(19) United States
(12) Patent Application Publication
(10) Pub. No.: US 2013/0050461 A1
(43) Pub. Date: Feb. 28, 2013

(54) INFORMATION PROCESSING APPARATUS, IMAGE CAPTURING APPARATUS AND CONTROL METHOD THEREOF

(71) Applicants: Yuki Wada, Yokohama-shi (JP); Takahiro Matsushita, Tokyo (JP)

(72) Inventors: Yuki Wada, Yokohama-shi (JP); Takahiro Matsushita, Tokyo (JP)

(73) Assignee: CANON KABUSHIKI KAISHA, Tokyo (JP)

(21) Appl. No.: 13/565,385

(22) Filed: Aug. 2, 2012

(30) Foreign Application Priority Data
Aug. 25, 2011 (JP) 2011-184065

(51) Int. Cl. H04N 7/18

(52) U.S. Cl. 348/77; 348/E07.085

(57) ABSTRACT

An information processing apparatus which specifies a person in image data, generates dictionary data in which unique information is registered for each person, stores the dictionary data in a storage unit, extracts a feature amount of an object in image data and checks the dictionary data to specify a person, communicates with an image capturing apparatus having a function of specifying a person in image data using dictionary data, compares dictionary data of the image capturing apparatus with the dictionary data stored in the storage unit when the information processing apparatus is communicating with the image capturing apparatus, and transmits the dictionary data stored in the storage unit, if the dictionary data stored in the storage unit is newer, to the image capturing apparatus to update the dictionary data of the image capturing apparatus.

### BACKGROUND OF THE INVENTION

1. Field of the Invention

The present invention relates to a technique for editing a face dictionary used to specify a person included in an image.

2. Description of the Related Art

In a personal computer (PC), camera, and the like, a technique for specifying a person included in an image at an image browsing/search timing and image capturing timing on an application which incorporates a face search algorithm is known. In order to specify a person, a face image of that person or a facial feature amount calculated from the face image is required. A face dictionary including pieces of unique information about a person is prepared by associating a person's name, face image data, facial feature amounts, and the like, with each other. In order to specify the name of a person included in an image, an application registers the face dictionary, clips a face image from an object included in an image which is captured by a camera and is displayed, and compares a facial feature amount calculated from the clipped face image with those of the face dictionary. When these facial feature amounts are approximate to each other, a person is identified. Then, since the facial feature amount is associated with a name, the name of the person or object included in that image can be specified.

For example, Picasa3 of Google can group and display face images having closer facial feature amounts. By appending the name of a person to that group, a face dictionary which associates the facial feature amounts of these images with the name of the person is generated. After that, when an image close to the facial feature amount is detected, it is added to the group.

However, if only one face dictionary is available per person, only an image close to face image data or a facial feature amount of that face dictionary is specified. For example, assuming that a face dictionary is generated from face images of a certain person of the age of twenty, it is difficult to specify that person from face images from childhood of that person. To solve this problem, Japanese Patent Laid-Open No. 2008-165314 has proposed the following technique. That is, a plurality of age-group face dictionaries of a person are provided to allow to specify that person from all face images from past to present of that person.

On the other hand, when a face dictionary generated by an application on a PC cannot be used by another device such as a camera, in order to specify a person by a camera which incorporates a face search algorithm, the face dictionary has to be registered on the camera. Japanese Patent Laid-Open No. 2008-165314 describes, as a method of writing a facial feature amount of a person in another device, a method of writing facial feature amount data stored in a PC or those stored in a camera A in a camera B. Also, Japanese Patent Laid-Open No. 2007-241782 describes a method which allows a camera to provide face registration files generated by the camera to an external device when the camera is connected to the external device, and to move, delete, correct, and load face registration files in an edit mode.

When there are a plurality of devices which specify a person in an image, it is desirable to specify the person based on equivalent criteria of judgment in all the devices. However, in order to specify a person based on the same criteria of judgment on the plurality of devices, the respective devices are required to have the same face dictionaries. In this case, face dictionaries of all persons are required to be stored. Such a storage requirement does not cause any serious problems in a PC or the like, which has a large storage capacity. However, since a camera or the like has a limited storage capacity, it is difficult to store all face dictionaries in addition to captured image data.

On the other hand, when facial feature amounts and face registration files are provided to another device, as described in Japanese Patent Laid-Open No. 2007-241782, if that device has already stored the facial feature amounts and face registration files, they have to be merged so as not to increase information volume to be stored in a device such as a camera which has a small storage capacity.

### SUMMARY OF THE INVENTION

The present invention has been made in consideration of the aforementioned problems, and realizes a technique which can set equivalent determination precision associated with specification of a person among a plurality of devices while suppressing storage capacity by providing the minimum required face dictionaries to a device which has a small storage capacity.

In order to solve the aforementioned problems, the present invention provides an information processing apparatus, which has a function of specifying a person included in image data, comprising: a generation unit configured to generate dictionary data in which unique information is registered for each person, and to store the dictionary data in a storage unit; a search unit configured to extract a feature amount of an object included in image data, and to check the dictionary data to specify a person; a communication unit configured to communicate with an image capturing apparatus having a function of specifying a person included in image data using dictionary data; and a transmitting unit configured to compare dictionary data of the image capturing apparatus with the dictionary data stored in the storage unit in a state in which the information processing apparatus is communicating with the image capturing apparatus via the communication unit, and to transmit the dictionary data stored in the storage unit, when the dictionary data stored in the storage unit is newer, to the image capturing apparatus to update the dictionary data of the image capturing apparatus.

In order to solve the aforementioned problems, the present invention provides an information processing apparatus, which has a function of specifying a person included in image data, comprising: a generation unit configured to generate dictionary data in which unique information is registered for each person, and to store the dictionary data in a storage unit; a search unit configured to extract a feature amount of an object included in image data, and to check the dictionary data to specify a person; a communication unit configured to communicate with an image capturing apparatus having a function of specifying a person included in image data using dictionary data; an acquisition unit configured to acquire dictionary data from the image capturing apparatus; a determination unit configured to determine whether or not the dictionary data acquired from the image capturing apparatus includes dictionary data of the same person as dictionary data stored in the storage unit; and a merge unit configured to merge the dictionary data of the same person acquired from the image capturing apparatus with the dictionary data of the same person stored in the storage unit.

In order to solve the aforementioned problems, the present invention provides an image capturing apparatus, which captures an image of an object, comprising: a generation unit configured to generate dictionary data in which unique information is registered for each person, and to store the dictionary data in a storage unit; a search unit configured to extract a feature amount of an object included in image data, and to check the dictionary data to specify a person; a communication unit configured to communicate with an information processing apparatus having a function of specifying a person included in image data using dictionary data; and an update unit configured to update, when dictionary data newer than the dictionary data stored in the storage unit is transferred from the information processing apparatus, the dictionary data stored in the storage unit to the newer dictionary data in a state in which the image capturing apparatus is communicating with the information processing apparatus via the communication unit.

In order to solve the aforementioned problems, the present invention provides an image capturing apparatus, which captures an image of an object, comprising: a generation unit configured to generate dictionary data in which unique information is registered for each person, and to store the dictionary data in a storage unit; a search unit configured to extract a feature amount of an object included in image data, and to check the dictionary data to specify a person; a communication unit configured to communicate with an information processing apparatus having a function of specifying a person included in image data using dictionary data; an acquisition unit configured to acquire dictionary data from the information processing apparatus; and a merge unit configured to merge dictionary data of the same person acquired from the information processing apparatus with dictionary data of the same person stored in the storage unit.

In order to solve the aforementioned problems, the present invention provides a control method of an information processing apparatus, which includes: a generation unit configured to generate dictionary data in which unique information is registered for each person, and to store the dictionary data in a storage unit; a search unit configured to extract a feature amount of an object included in image data, and to check the dictionary data to specify a person; and a communication unit configured to communicate with an image capturing apparatus having a function of specifying a person included in image data using dictionary data, the method comprising: a step of comparing dictionary data of the image capturing apparatus with the dictionary data stored in the storage unit in a state in which the information processing apparatus is communicating with the image capturing apparatus via the communication unit; and a step of transmitting the dictionary data stored in the storage unit, when the dictionary data stored in the storage unit is newer, to the image capturing apparatus to update the dictionary data of the image capturing apparatus.

In order to solve the aforementioned problems, the present invention provides a control method of an information processing apparatus, which includes: a generation unit configured to generate dictionary data in which unique information is registered for each person, and to store the dictionary data in a storage unit; a search unit configured to extract a feature amount of an object included in image data, and to check the dictionary data to specify a person; and a communication unit configured to communicate with an image capturing apparatus having a function of specifying a person included in image data using dictionary data, the method comprising: an acquisition step of acquiring dictionary data from the image capturing apparatus; a determination step of determining whether or not the dictionary data acquired from the image capturing apparatus includes dictionary data of the same person as dictionary data stored in the storage unit; and a merge step of merging the dictionary data of the same person acquired from the image capturing apparatus with the dictionary data of the same person stored in the storage unit.

In order to solve the aforementioned problems, the present invention provides a control method of an image capturing apparatus, which has: an image capturing unit configured to capture an image of an object; a generation unit configured to generate dictionary data in which unique information is registered for each person, and to store the dictionary data in a storage unit; a search unit configured to extract a feature amount of the object included in image data, and to check the dictionary data to specify a person; and a communication unit configured to communicate with an information processing apparatus having a function of specifying a person included in image data using dictionary data, the method comprising: a step of updating, when dictionary data newer than the dictionary data stored in the storage unit is transferred from the information processing apparatus, the dictionary data stored in the storage unit to the newer dictionary data in a state in which the image capturing apparatus is communicating with the information processing apparatus via the communication unit.

In order to solve the aforementioned problems, the present invention provides a control method of an image capturing apparatus, which has: an image capturing unit configured to capture an image of an object; a generation unit configured to generate dictionary data in which unique information is registered for each person, and to store the dictionary data in a storage unit; a search unit configured to extract a feature amount of the object included in image data, and to check the dictionary data to specify a person; and a communication unit configured to communicate with an information processing apparatus having a function of specifying a person included in image data using dictionary data, the method comprising: an acquisition step of acquiring dictionary data from the information processing apparatus; and a merge step of merging dictionary data of the same person acquired from the information processing apparatus with dictionary data of the same person stored in the storage unit.

According to the present invention, equivalent determination precision associated with specification of a person can be set among a plurality of devices while suppressing a storage capacity, by providing minimum required face dictionaries to a device having a small storage capacity.

Further features of the present invention will become apparent from the following description of exemplary embodiments (with reference to the attached drawings).

### BRIEF DESCRIPTION OF THE DRAWINGS

FIG. 1A is a block diagram showing the arrangement of an image capturing apparatus according to an embodiment of the present invention;

FIG. 1B is a block diagram showing the arrangement of an information processing apparatus according to the embodiment of the present invention;

FIG. 2A shows an example of the data configurations of face dictionaries in a PC according to the embodiment;

FIG. 2B shows an example of the data configurations of face dictionaries in a digital camera according to the embodiment;

FIG. 3 is a flowchart showing write processing of a face dictionary to the camera by the PC according to the embodiment;

FIG. 4 is a flowchart showing addition processing of a face dictionary to the camera by the PC according to the embodiment;

FIG. 5 shows an example of a dialog used to select a face dictionary of a person to be added to the camera in FIG. 4;

FIG. 6 is a flowchart showing transfer processing of image data from the PC to the camera according to the embodiment;

FIG. 7 is a flowchart showing deletion processing of image data in the camera according the embodiment;

FIG. 8 is a flowchart showing image capturing processing of the camera according to the embodiment;

FIG. 9 shows a display example in which a person is specified at an image capturing timing of the camera according to the embodiment, and the name of that person is displayed in association with an object;

FIG. 10 shows an example of a dialog used to register a face dictionary of a new person according to the embodiment;

FIG. 11 is a flowchart showing processing for merging face dictionaries and transferring the merged face dictionary to the camera in the PC according to the embodiment;

FIG. 12 is a flowchart showing processing for merging face dictionaries of the PC and camera in step S1103 in FIG. 11;

FIG. 13 is a flowchart showing switching processing of merge processing according to a determination result of face search algorithms in the camera and PC;

FIG. 14 is a flowchart showing selection processing of a main body used to execute marge processing in step S1305 in FIG. 13;

FIG. 15 is a flowchart showing processing for transferring face images to the camera and merging face dictionaries in the camera in step S1309 in FIG. 13;

FIG. 16 shows an example of a dialog used to change a threshold of a similarity in face detection processing according to the embodiment;

FIG. 17A shows an example of a setting screen upon merging names of persons according to the embodiment;

FIG. 17B shows an example of a setting screen used to select a main body used to merge face dictionaries according to the embodiment;

FIG. 18 is an explanatory view of processing for transferring face images to the camera and merging face dictionaries in the camera in step S1305 in FIG. 13;

FIG. 19 is an explanatory view of processing for transferring facial feature amounts to the camera and merging facial feature amounts in the camera in step S1308 in FIG. 13;

FIG. 20 is an explanatory view of processing for merging face dictionaries in the PC and transferring the merged face dictionaries to the camera in step S1307 in FIG. 13;

FIG. 21 is an explanatory view of processing executed when an application on the PC side compares facial feature amounts of face dictionaries in the PC and camera, and merges the face dictionaries;

FIG. 22 shows an example of a window which displays images registered in a face dictionary in the application of the PC;

FIG. 23 shows an example of a dialog used to select a face dictionary to be transferred from the PC to the camera;

FIG. 24A shows an example of a dialog used to select face images used in the face search algorithm in the application of the PC;

FIG. 24B shows an example of a dialog used to transfer a face dictionary of the PC to the camera in the application of the PC;

FIG. 25A shows a dialog used to select face images from an unknown person;

FIG. 25B shows a display example of a warning message when a face dictionary of the same name is found upon transferring a face dictionary from the PC to the camera;

FIG. 26A shows an example of a dialog used to select a representative image when a face dictionary of a single person includes a plurality of face images;

FIG. 26B shows an example of a dialog used to prompt the user to confirm if the face dictionary from which the representative image is selected is to be written in the camera when the face dictionary of a single person includes a plurality of face images;

FIG. 27A shows an example of a dialog displayed during write processing of a face dictionary from the PC to the camera; and

FIG. 27B shows an example of a dialog displayed when the write processing of a face dictionary from the PC to the camera is complete.

### DESCRIPTION OF THE EMBODIMENTS

Embodiments of the present invention will be described in detail below. The following embodiments are merely examples for practicing the present invention. The embodiments should be properly modified or changed depending on various conditions and the structure of an apparatus to which the present invention is applied. The present invention should not be limited to the following embodiments. Also, parts of the embodiments to be described later may be properly combined.

### First Embodiment

An example in which an image processing system of the present invention is realized by connecting a personal computer (to be referred to as a “PC” hereinafter) as an information processing apparatus, and a digital camera (to be referred to as a “camera” hereinafter) as an image capturing apparatus to be able to communicate with each other will be described. In this system, when a face dictionary of the PC is newer than that of the camera, the face dictionary of the camera is written into that of the PC, and dictionary edit applications (to be referred to as “applications” hereinafter) installed in the PC and camera execute processing. Note that as in embodiments to be described later, face search algorithms on the applications of the PC and camera may often be different or changed.

<Arrangement of Camera>

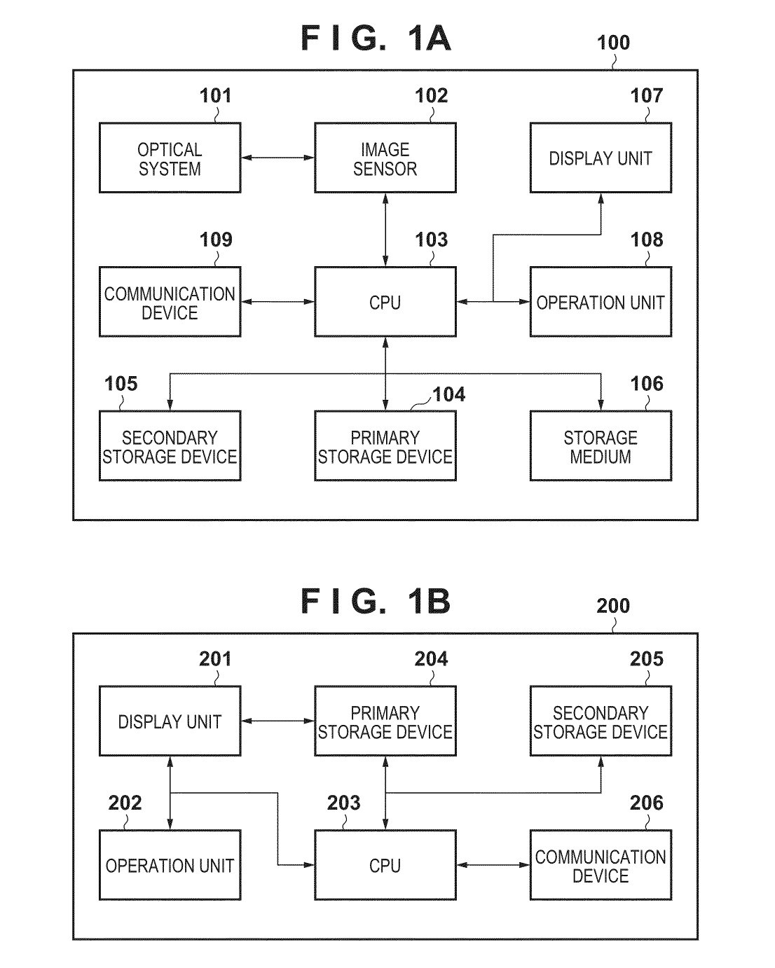

The arrangement of the camera according to this embodiment will be described below with reference to FIG. 1A.

Referring to FIG. 1A, the camera 100 includes an optical system 101, image sensor 102, CPU 103, primary storage device 104, secondary storage device 105, storage medium 106, display unit 107, operation unit 108, and communication device 109.

The optical system 101 includes a lens, shutter, and diaphragm, and images light coming from an object on the image sensor 102 to have an appropriate amount and timing. The image sensor 102 converts light imaged via the optical system 101 into an electrical signal. The CPU 103 makes various calculations and controls respective units included in the camera 100 in accordance with input signals and programs. The primary storage device 104 is a volatile memory which stores temporary data and is used as a work area of the CPU 103. The secondary storage device 105 is, for example, a hard disk drive, and stores programs (firmware) and various kinds of setting information required to control the camera 100. The storage medium 106 stores captured image data, face dictionaries, and the like. Note that the storage medium 106 is detachable from the camera 100. When the storage medium 106 is attached to a PC 200 (to be described later), image data can be read out from the storage medium 106. That is, the camera 100 need only have an access means to the storage medium 106 and execute read/write accesses of data to the storage medium 106. Note that face dictionaries are stored in the storage medium 106, but they may be stored in the secondary storage device 105. The display unit 107 displays a viewfinder image at an image capturing timing, captured images, characters required for interactive operations, and the like. Registration processing of face dictionaries and display processing of registered face dictionaries are also executed by the display unit 107. The operation unit 108 accepts user operations. The operation unit 108 can use, for example, buttons, levers, a touch panel, and the like. The communication device 109 establishes connection to an information processing apparatus such as a PC to exchange control commands and data. As a protocol required to establish connection to the information processing apparatus and to allow data communications, for example, PTP (Picture Transfer Protocol) or MTP (Media Transfer Protocol) is used. Note that the communication device 109 may make communications via a wired connection using, for example, a USB (Universal Serial Bus) cable, or a wireless connection such as a wireless LAN. Also, the communication device 109 may be connected to the information processing apparatus directly or via a server or a network such as the Internet.

<Arrangement of PC>

The arrangement of the PC of this embodiment will be described below with reference to FIG. 1B.

Referring to FIG. 1B, a PC 200 includes a display unit 201, operation unit 202, CPU 203, primary storage device 204, secondary storage device 205, and communication device 206. Basic functions of the components are the same as those of the camera 100, and a detailed description thereof will not be repeated. Note that the display unit 201 adopts a liquid crystal display panel (LCD) or the like. Also, the PC 200 need not include the display unit 201, and need only have a display control function of controlling display of the display unit 201. The operation unit 202 adopts a keyboard, mouse, and the like, and is used by, for example, the user to input the name of a person.

<Data Configuration of Face Dictionary>

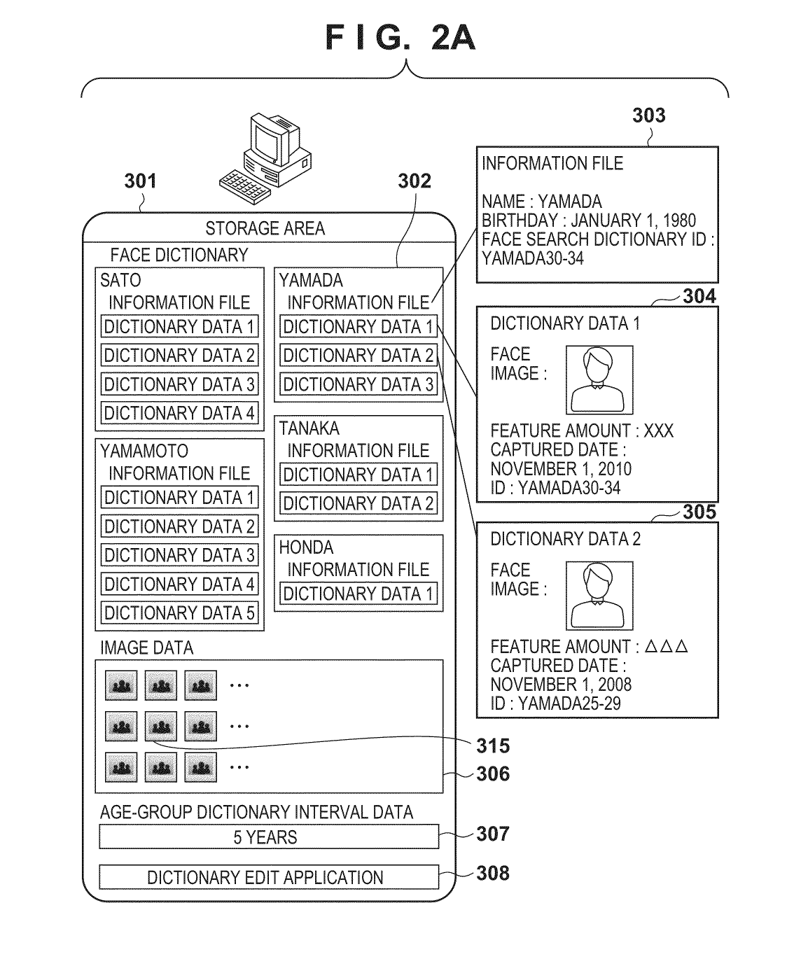

The data configuration of a face dictionary will be described below with reference to FIGS. 2A and 2B.

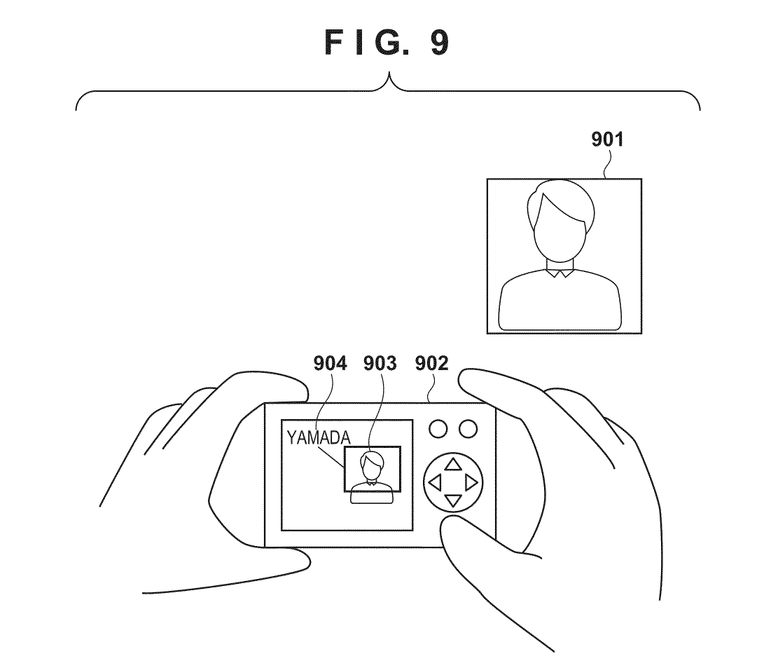

Referring to FIG. 2A, face dictionaries are stored in a storage area 301 of the secondary storage device 205 in the PC 200. The face dictionaries are classified into folders 302 for respective persons. The folder 302 of each person stores an information file 303 and a plurality of dictionary data. Each dictionary data describes a facial feature amount required to specify a person (for example, a value which represents the size and color of a face, and features of portions such as eyes and nose), a captured date, and an ID (identification information). An information file 303, the name and birthday of a person, and an ID of dictionary data (face search dictionary data) are used at an image capturing timing. The information file 303 is generated when the user inputs the name and birthday of a person on a dialog 1000 which is displayed on the PC 200 or camera 100 and shown in FIG. 10. Reference numeral 1001 denotes face image data used as face search dictionary data. The user inputs the name and birthday of a person of the face image 1001 in input fields 1002 and 1003, and then clicks an OK button 1004, thus registering a face dictionary of a new user. The name of the person in the information file 303 is used when a facial feature amount is extracted from face image data to check a face dictionary and to specify a person, and the name of the person is displayed on that face image. The birthday of the information file 303 is used to calculate the age of a person included in an image from the captured date of the image. The face search dictionary data in the information file 303 indicates dictionary data having the newest captured date of those of that person. For example, an ID or file name indicating face search dictionary data need only be designated in the information file 303.

The PC 200 is installed with a dictionary edit application 308 and stores image data 306.

Dictionary data include those at intervals of the predetermined number of years. That interval is the number of years indicated by age-group dictionary interval data 307. For example, when “5 years” is described in the data 307, dictionary data are generated at 5-year intervals. Dictionary data 304 is used to search for face images when Yamada was 30 to 34 years old, and dictionary data 305 is used to search for face images when Yamada was 25 to 29 years old. The ID of the dictionary data is set to recognize an age range. For example, the ID of the dictionary data 304 is set to be, for example, “Yamada30-34”. The data 307 describes “5 years”, but this number of years need not be constant. It is more preferable to flexibly set the dictionary interval data. For example, since a face tends to change in childhood, dictionary data may be generated year by year until 10 years old, may be generated at 3-year intervals after 10 years old, may be generated at 5-year intervals after 20 years old, and so forth.

In the dictionary data of each age group, a predetermined number of facial feature amounts (for example, five to ten facial feature amounts per person) may be registered. In this manner, since dictionary data can be prevented from having an extremely large size, a limited storage capacity of the camera 100 can be prevented from being burdened upon sharing dictionary data.

Note that each age-group face dictionary data is associated with a captured date information range of images. For example, the aforementioned dictionary data 304 is associated with a date range required to specify images when Mr. Yamada was 30 to 34 years old.

In order to search an image for a face, image captured date information is referred to, and a face dictionary corresponding to that captured date information is used. In this way, a face search can be conducted using a face dictionary suited to the age of an object.

Referring to FIG. 2B, a storage area 309 of the secondary storage device 105 of the camera 100 stores minimum required face dictionaries. As a face dictionary, a folder 310 for each person stores an information file 311 and required dictionary data 312 and 317. On the other hand, the camera 100 is installed with a dictionary edit application 314, and stores image data 313.

Note that when face search algorithms on the applications of the PC 200 and camera 100 are different, they normally calculate different facial feature amounts even for an identical image. Therefore, an ID is a value unique to face search dictionary data used to calculate a facial feature amount from a face image, and is used to determine whether or not different or identical face search algorithms are used, as will be described later. For this reason, when the face search algorithm is changed, the ID is also changed even for identical dictionary data.

<Write Processing of Face Dictionary>

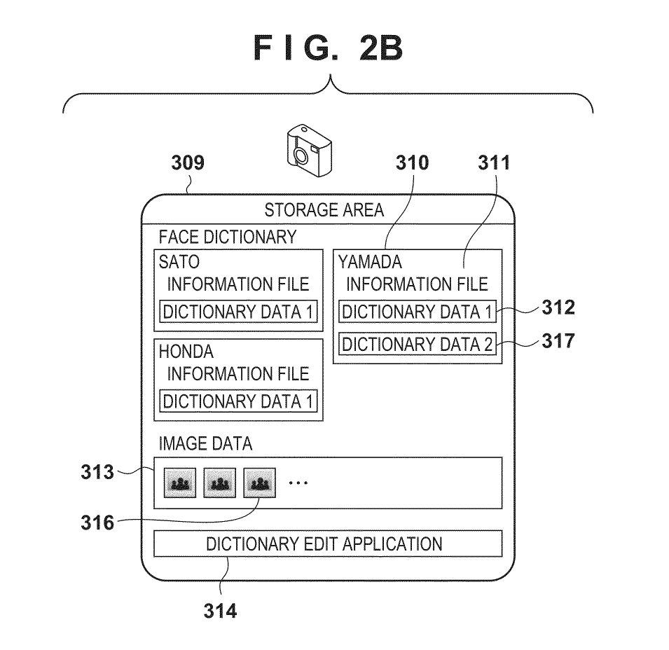

Write processing of a face dictionary from the PC to the camera will be described below with reference to FIG. 3. Note that processes to be described below are executed by the applications installed in the PC 200 and camera 100.

Referring to FIG. 3, in step S301, the camera 100 and PC 200 are connected, and a communication between the camera 100 and PC 200 is established via the communication devices 109 and 206.

In step S302, the user launches the application on the PC 200 and executes “write face dictionary” while the camera 100 and PC 200 are connected. This function may be automatically executed when the camera 100 and PC 200 are connected in step S301. In step S303, face dictionary data (for example, the dictionary data 304 and 312) of the same person in the camera 100 and PC 200 are compared based on their captured dates. The dictionary data which has the newest captured date of those data of that person is selected. Whether or not that dictionary data is face search dictionary data is judged using the information files 303 and 311 of that person. As a result of the comparison, if the dictionary data 304 of the PC 200 is newer, the process advances to step S304; if the dictionary data 312 of the camera 100 is newer, since the dictionary data 310 of the camera 100 need not be updated, this processing ends.

It is determined in step S304 whether or not the storage capacity of the camera 100 is equal to or larger than a predetermined value; that is, whether or not the camera 100 has at least a remaining storage capacity enough to store face dictionary data transferred from the PC 200. If the storage capacity of the camera 100 is insufficient, since the face dictionary cannot be written in the camera 100, for example, a warning message indicating an insufficient storage capacity of the camera 100 is displayed for the user in step S310. In response to this warning display, the user deletes face dictionary data and image data stored in the camera 100 to assure sufficient storage capacity, and executes step S302 again. On the other hand, if it is determined in step S304 that the camera 100 has a sufficient storage capacity, the process advances to step S305, and the information files 303 and 311 of the PC 200 and camera 100 describe the same ID of face search dictionary data. The reason why the ID is determined in step S305 is to confirm whether dictionary data to be transferred to the camera 100 is newly generated data or is used to update existing dictionary data, since the dictionary data are generated at predetermined time intervals.

If it is determined in step S305 that the information files describe the same ID, the face search dictionary data of the face dictionary of the camera 100 is deleted in step S307 so as to update the dictionary data of the camera 100. On the other hand, if it is determined that the information files do not describe the same ID, it is determined in step S306 whether or not image data of the camera 100 include that searchable by the face search dictionary data of the camera 100. The reason why step S306 is to be executed is that the camera 100 can basically store face search dictionary data, but it requires dictionary data other than the face search dictionary data to search for image data, and whether or not to delete old dictionary data is judged. If no searchable image data is included in step S306, that dictionary data is not necessary, and is deleted in step S307. On the other hand, if searchable image data is included, since that dictionary data is necessary for a face search, it is not deleted. The process then advances to step S308, and the face search dictionary data of the face dictionary of the PC 200 is transferred to the camera 100. In step S309, the face search dictionary data transferred from the PC 200 is written in the face dictionary of the camera 100 to update the ID of the face search dictionary data of the camera 100 by that of the dictionary data of the PC 200.

When the camera 100 stores face dictionaries for a plurality of persons, the aforementioned processing is repetitively executed as many as the number of persons.

In this manner, since the face search dictionary data of the camera 100 is updated to the latest version, person specifying precision can be improved. Since old dictionary data which becomes unnecessary is deleted, while the required dictionary data is left, only minimum required dictionary data can be stored in the camera 100 while suppressing a storage capacity of the camera 100.

<Addition Processing of Face Dictionary>

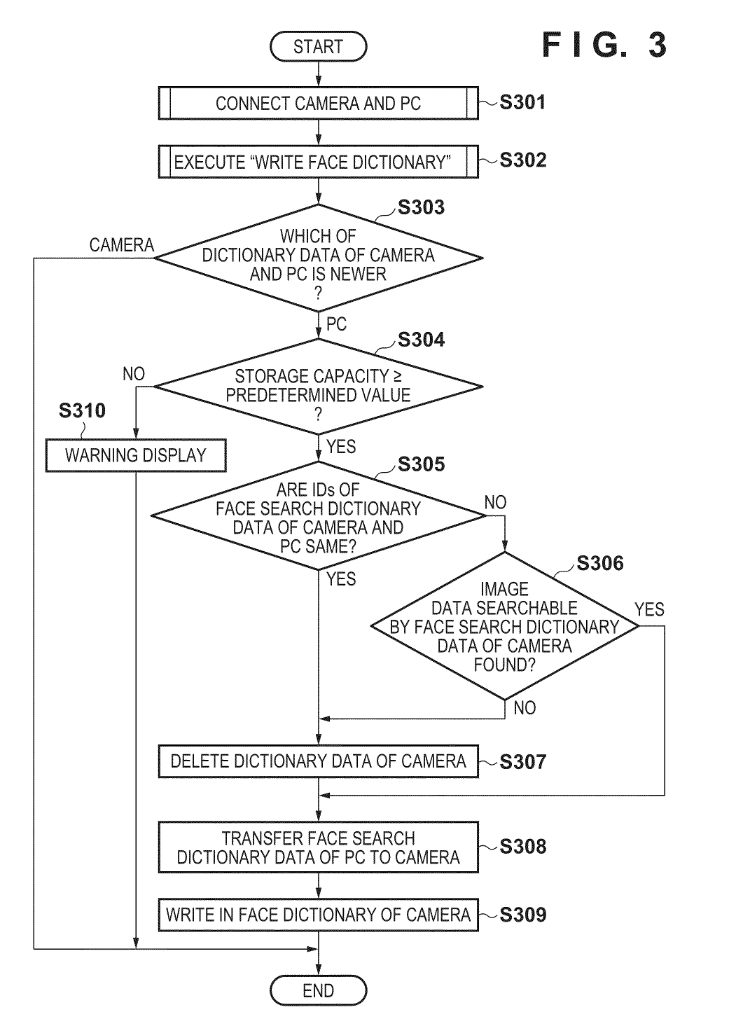

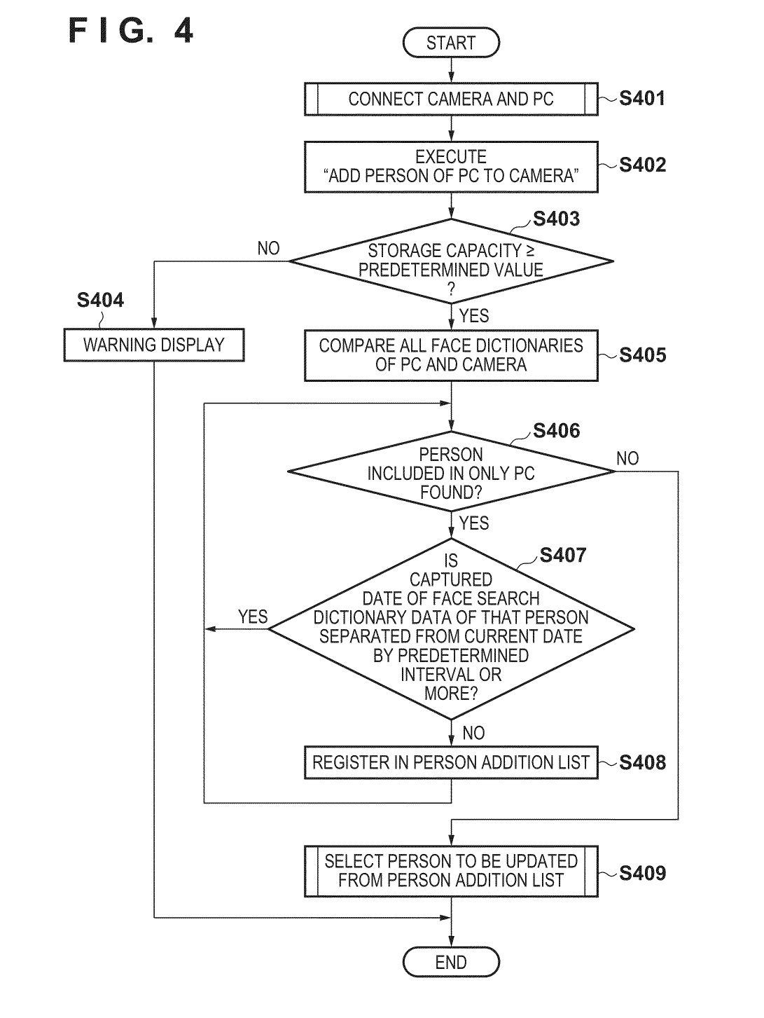

Processing for transferring a face dictionary, which is found in the PC 200 but is not found in the camera 100, from the PC 200 to the camera 100 will be described below with reference to FIGS. 4 and 5. The arrangements of the camera 100 and PC 200, and the configuration of the face dictionary are the same as those described using FIGS. 1A and 1B and FIGS. 2A and 2B. Note that processes to be described below are executed by the applications installed in the PC 200 and camera 100.

Referring to FIG. 4, in step S401, the camera 100 and PC 200 are connected, and a communication between the camera 100 and PC 200 is established via the communication devices 109 and 206.

In step S402, the user launches the application on the PC 200 and executes “add face dictionary of PC to camera” while the camera 100 and PC 200 are connected. This function may be automatically executed when the camera 100 and PC 200 are connected in step S401.

It is determined in step S403 whether or not the storage capacity of the camera 100 is equal to or larger than a predetermined value, that is, whether or not the camera 100 has at least a remaining storage capacity enough to store face dictionary data transferred from the PC 200. If the storage capacity of the camera 100 is insufficient, since the face dictionary cannot be written in the camera 100, for example, a warning message indicating an insufficient storage capacity of the camera 100 is displayed for the user in step S404. In response to this warning display, the user deletes face dictionary data and image data stored in the camera 100 to assure a sufficient storage capacity, and executes step S402 again. On the other hand, if it is determined in step S403 that the camera 100 has a sufficient storage capacity, the process advances to step S405, and the names of persons described in the information files 303 and 311 of all face dictionaries of the PC 200 and camera 100 are compared. As a result of comparison, it is determined in step S406 whether or not a face dictionary of a person, which is not stored in the camera 100 but is stored in only the PC 200, is found. For example, referring to FIGS. 2A and 2B, a face dictionary of Yamada is stored in both the PC 200 and camera 100, but that of Tanaka is stored in only the PC 200. If a face dictionary of a person, which is stored in only the PC 200, is found in step S406, it is determined in step S407 whether or not the captured date of face search dictionary data of that person is separated from the current date by a predetermined interval (age-group dictionary interval data 307) or more. The reason why step S407 is executed is as follows. Since face search dictionary data is used at an image capturing timing, a facial feature amount is required to be similar to that of the current real-life person, and dictionary data for an older age even for the real-life person cannot improve precision as the face search dictionary data. If the captured date is separated by the predetermined interval or more in step S407, even when the face search dictionary data of that person is transferred to the camera 100, it cannot be used at an image capturing timing. Hence, the process returns to step S406, and the same processing is executed for a face dictionary of another person, which is stored in only the PC 200. On the other hand, if the captured date is not separated by the predetermined interval or more in step S407, the person of interest is registered in a person addition list in step S408 so as to transfer a new face dictionary to the camera 100, and the process returns to step S406. If no person addition list is available in step S408, a new list is generated.

If no face dictionary of another person, which is stored in only the PC 200, is found in step S406, the user arbitrarily selects a face dictionary of a person to be transferred to the camera 100 from the person addition list by displaying a dialog 500 shown in FIG. 5 on the PC 200 in step S409. The dialog 500 displays face images 502 of face search dictionary data and names 503 of persons. The user selects a face dictionary by checking a check box 501 of a person to be added from the person addition list. Note that face dictionaries of all persons in the person addition list may be transferred to the camera 100 without displaying any UI such as the dialog 500.

In this manner, since only a face dictionary selected by the user can be transferred to the camera 100, only minimum required face dictionaries can be stored in the camera 100 while suppressing the storage capacity of the camera 100.

<Transfer Processing of Image Data>

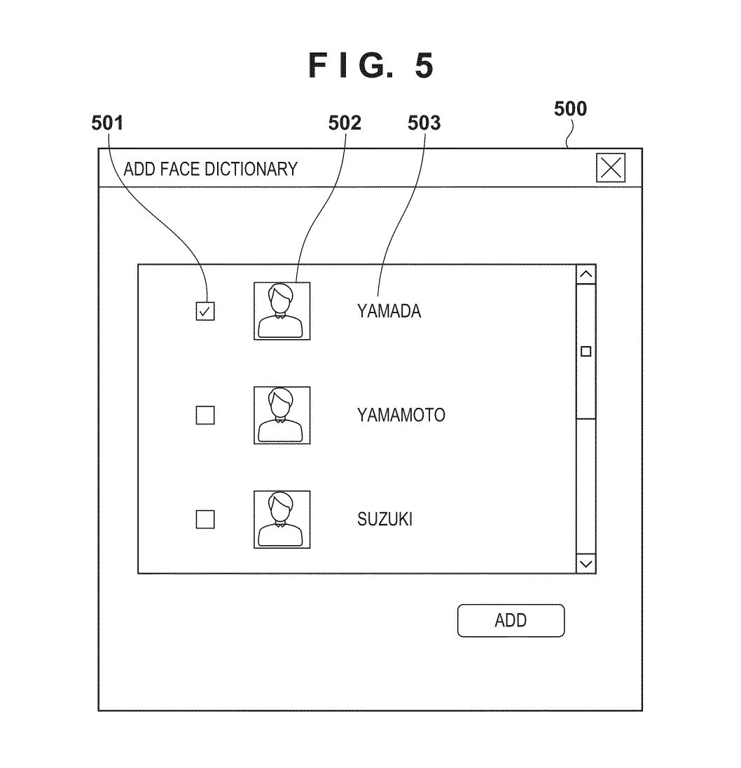

Processing for transferring dictionary data which can specify a person included in image data stored in the PC 200 to the camera 100 upon transferring that image data to the camera 100 will be described below with reference to FIG. 6. The arrangements of the camera 100 and PC 200, and the configuration of dictionary data are the same as those described using FIGS. 1A and 1B and FIGS. 2A and 2B. Note that processes to be described below are executed by the applications installed in the PC 200 and camera 100.

Referring to FIG. 6, in step S601, the camera 100 and PC 200 are connected, and a communication between the camera 100 and PC 200 is established via the communication devices 109 and 206.

In step S602, the user launches the application on the PC 200 and executes “transfer to camera” while the camera 100 and PC 200 are connected. In step S602, the user selects an image to be transferred to the camera 100 at the PC 200. In this case, assume that the user selects image data 315 in FIG. 2A. When the user wants to transfer a plurality of images, he or she may select the plurality of images, and may transfer them to the camera 100 together.

It is determined in step S603 whether or not the storage capacity of the camera 100 is equal to or larger than a predetermined value, that is, whether or not the camera 100 has at least a remaining storage capacity enough to store image data and face dictionary data transferred from the PC 200. If the storage capacity of the camera 100 is insufficient, since image data and dictionary data cannot be transferred to the camera 100, for example, a warning message indicating an insufficient storage capacity of the camera 100 is displayed for the user in step S610. In response to this warning display, the user deletes face dictionary data and image data stored in the camera 100 to assure a sufficient storage capacity, and executes step S602 again. On the other hand, if it is determined in step S603 that the camera 100 has a sufficient storage capacity, the process advances to step S604, and the image data 315 selected by the user in step S602 is transferred to the camera 100. In this case, the image data 315 to be transferred to the camera 100 is not deleted from the PC 200, but it is copied to the camera 100.

In step S605, a face image is clipped from the image data 315 transferred to the camera 100, and a facial feature amount is extracted from the face image data to search all face dictionaries of the PC 200. In step S605, processing opposite to the sequence for specifying a person based on a face dictionary generated from face image data is executed, but it uses the same method.

It is determined in step S606 whether or not a corresponding face dictionary is found in the PC 200 as a result of the search. In this step, the facial feature amount calculated from the face image clipped from the image data 315 in step S605 is compared with those of the face dictionaries of the PC 200 to determine whether or not face dictionaries having similarities equal to or larger than a threshold are found. If no corresponding face dictionary is found in the PC 200 in step S606, since there is no face dictionary to be transferred to the camera 100, this processing ends. On the other hand, if a corresponding face dictionary is found, since this means that the dictionary data 305 which can specify a person included in the image data 315 is found, the process advances to step S607.

In order to confirm whether or not the dictionary data 305 to be transferred from the PC 200 to the camera 100 is already stored in the camera 100, it is determined in step S607 whether or not dictionary data having the same ID is stored in the camera 100. If dictionary data having the same ID is stored in the camera 100 in step S607, since that dictionary data need not be transferred to the camera 100, this processing ends. On the other hand, if no dictionary data having the same ID is stored in the camera 100, the dictionary data 305 is transferred from the PC 200 to the camera 100 in step S608. In this step, the dictionary data 305 transferred to the camera 100 is not deleted from the PC 200, but it is copied to the camera 100.

Upon transferring the dictionary data to the camera 100 in step S608, when the image selected by the user in step S602 includes a plurality of persons, the user may select face dictionaries of persons to be transferred to the camera 100 using the dialog 500 shown in FIG. 5, as in FIG. 4. Also, when the user selects a plurality of images in step S602, he or she may select face dictionaries of persons to be transferred to the camera 100 using the dialog 500 shown in FIG. 5.

In this manner, even the camera 100 can specify a person from an image transferred from the PC 200 to the camera 100 with the same determination precision as in PC 200.

<Deletion Processing>

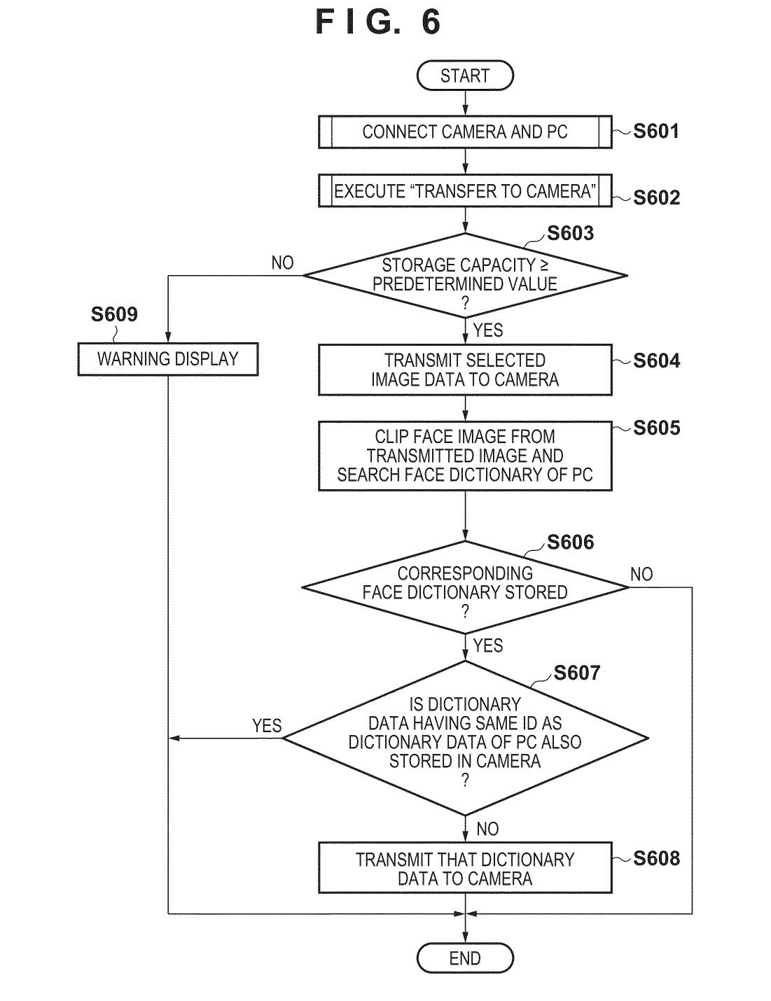

Processing for simultaneously deleting dictionary data which can specify a person included in image data to be deleted upon deleting the image data of the camera 100 will be described below with reference to FIG. 7. The arrangements of the camera 100 and PC 200, and the configuration of dictionary data are the same as those described using FIGS. 1A and 1B and FIGS. 2A and 2B. Note that processes to be described below are executed by the applications installed in the PC 200 and camera 100.

Referring to FIG. 7, in step S701, the user launches the application of the camera 100, and executes “delete image from camera”. In step S701, the user selects image data to be deleted from the camera 100. Assume that the user selects image data 316 in FIG. 2B. When the user wants to delete a plurality of images, he or she may select the plurality of images and may delete them from the camera 100 together.

In step S702, a face image of a person is clipped from the image data 316, and a facial feature amount is calculated. In order to search for dictionary data of a face dictionary which can specify the person included in the image data 316, the facial feature amount calculated in step S702 is compared with those of dictionary data of face dictionaries of the camera 100 in step S703. As a result of search, if no corresponding dictionary data is found in step S704, since no dictionary data which can specify the person included in the image data 316 is found in the camera 100, the image data 316 selected by the user is deleted in step S707, thus ending this processing.

On the other hand, if corresponding dictionary data 317 is found in step S704, all image data of the camera 100 are searched in step S705 to determine whether or not image data which can specify the person based on the dictionary data 317 is stored. In step S705, whether or not the dictionary data 317 is used to specify the person of other image data is confirmed. If no image data which can specify the person based on the dictionary data 317 is stored in step S705, the dictionary data 317 is deleted in step S706. On the other hand, if image data which can specify the person is stored, since the dictionary data 317 is required to specify the person, it is not deleted, and the image data 316 selected by the user is deleted in step S707, thus ending this processing.

In this manner, since unnecessary dictionary data is simultaneously deleted upon deleting image data from the camera 100, the storage capacity of the camera 100 can be suppressed.

<Person Specifying Processing>

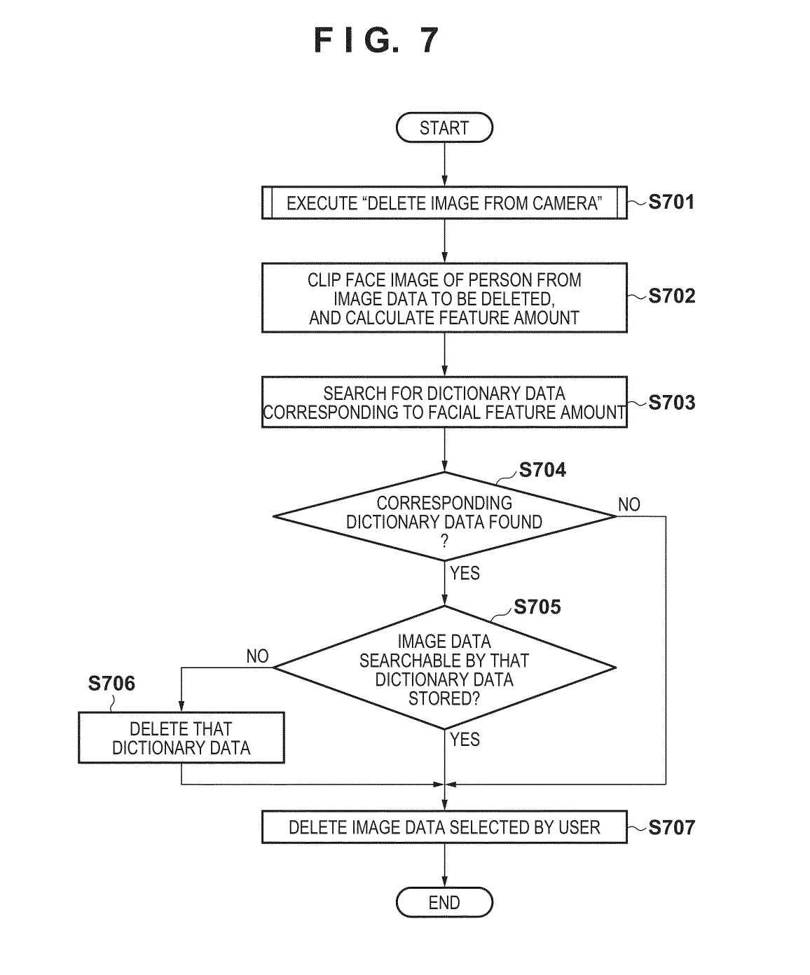

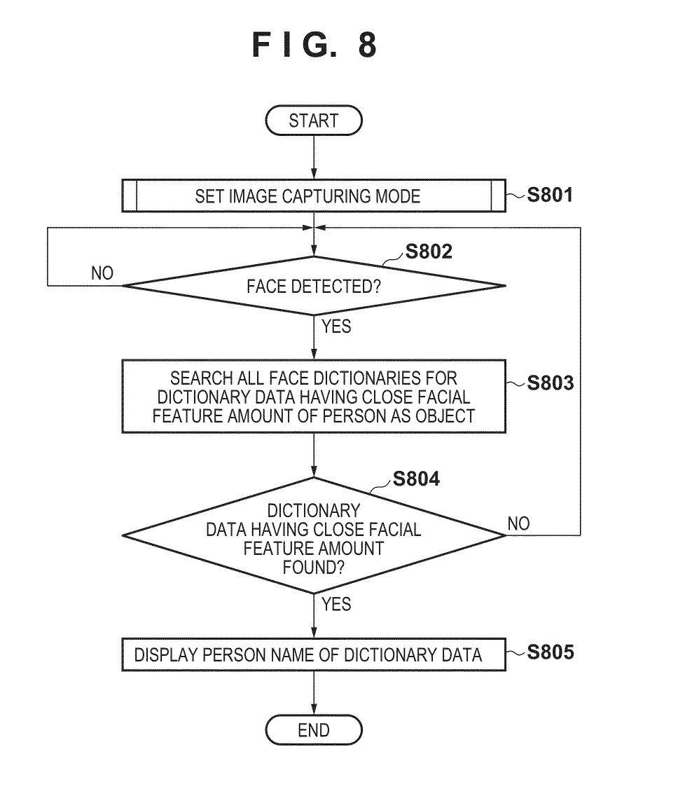

Processing for specifying a person as an object at an image capturing timing using face search dictionary data of the camera 100 will be described below with reference to FIGS. 8 and 9. The arrangements of the camera 100 and PC 200, and the configuration of dictionary data are the same as those described using FIGS. 1A and 1B and FIGS. 2 A and 2B. Note that processes to be described below are executed by the applications installed in the PC 200 and camera 100.

Referring to FIG. 8, in step S801, the user sets the camera 100 in an image capturing mode (a camera 902 in FIG. 9). Since processing for detecting a face of a person 901 from an image captured by the camera 100 is known, a description thereof will not be given. For example, if a face 903 of a person is detected in step S802 under the assumption that the object 901 is Yamada, face search dictionary data of all persons of the camera 100 are searched for dictionary data having a similarity with a facial feature amount of the person as the object, which similarity is equal to or larger than a threshold in step S803. As a result of the search, if dictionary data having an approximate facial feature amount is found in step S804, the name of a person is acquired from the information file 303 of the dictionary data to display a name 904 of that person on the display unit 107 in step S805.

In this way, since a plurality of dictionary data are searched for face search dictionary data closer to a facial feature amount of a captured object, and the found face search dictionary data is used, a person can be quickly specified. The reason why only face search dictionary data is to be searched in the image capturing mode is that the face search dictionary data has the latest captured date of a plurality of dictionary data, and has a facial feature amount closest to that of the object at the current time. For this reason, only the face search dictionary data is written from the PC 200 in the camera 100 in FIGS. 3 and 4.

### Second Embodiment

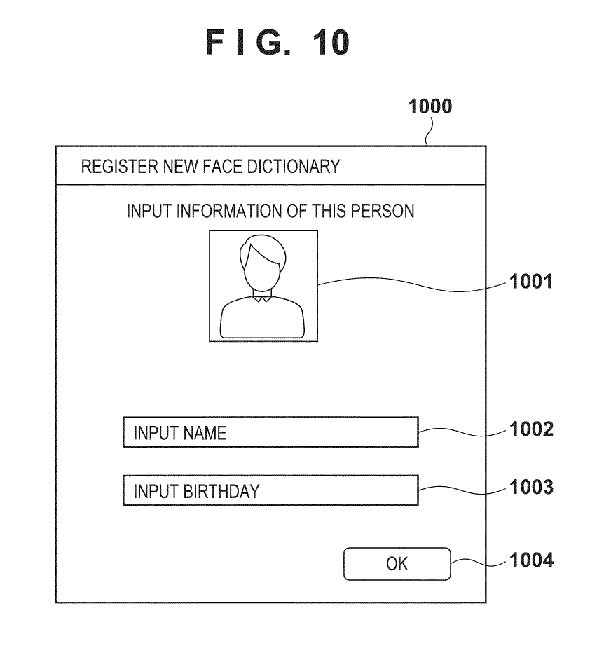

As the second embodiment, processing for merging face dictionaries in the PC 200 and transferring the merged face dictionary to the camera 100 will be described below with reference to FIG. 11. The arrangements of the camera 100 and PC 200, and the configuration of dictionary data are the same as those described using FIGS. 1A and 1B and FIGS. 2A and 2B. Note that processes to be described below are executed by the applications installed in the PC 200 and/or camera 100.

Referring to FIG. 11, it is determined in step S1101 whether or not the PC 200 and camera 100 are connected, and “write face dictionary in camera” is executed for the camera 100.

In step S1102, face dictionaries of the camera 100 are copied to a storage area of the primary storage device 204 of the PC 200.

In step S1103, face dictionaries of the PC 200 are merged with those of the camera 100.

In step S1104, the merged face dictionaries are transferred to the camera 100.

In step S1105, data are deleted from the storage area of the primary storage device 204 of the PC 200.

<Merge Processing>

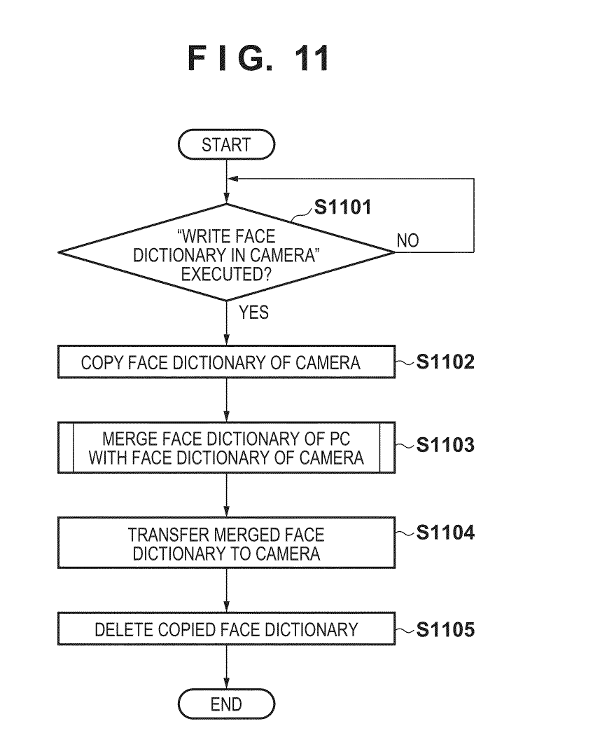

The merge processing in step S1103 in FIG. 11 will be described below with reference to FIG. 12.

Referring to FIG. 12, it is determined in step S1201 whether or not all face dictionaries of the camera 100 are compared with those of the PC 200. If comparison of all the face dictionaries is complete, this processing ends. On the other hand, if comparison of all the face dictionaries is not complete yet, the process advances to step S1202, and a person name of a face dictionary of the camera 100 is compared with that of a face dictionary of the PC 200. In this case, a face dictionary is prepared by associating a facial feature amount of a certain image with the name of a person.

It is determined in step S1203 whether or not the person names match. If the person names match, the process advances to step S1204, and a facial feature amount of the camera 100 is added to a group having the same person name. This is because since the person name is the same, a person is identified before comparison of facial feature amounts, and a face feature amount is registered to the same group, resulting in high convenience. Note that matching conditions of person names include not only a case in which character strings perfectly match but also a case in which the person names allow to estimate an identical person like “TARO YAMADA” and “Yamada Taro”. However, when character strings do not perfectly match like in the latter case, the user can select if face dictionaries are to be added to the same group and if either of these names is used as a group name.

If the person name of the face dictionary of the camera 100 does not match that of the face dictionary of the PC 200 in step S1203, a similarity between facial feature amounts of the camera 100 and PC 200 is compared in step S1205.

It is determined in step S1206 whether or not the similarity is equal to or larger than a threshold. If the similarity is equal to or larger than the threshold, the process advances to step S1207, and the facial feature amount of the camera 100 is added to the same group as the facial feature amount, the similarity of which is equal to or larger than the threshold. Note that when a single face dictionary group includes a plurality of facial feature amounts, representative facial feature amounts are selected from them, and are compared. If their similarity is equal to or larger than the threshold, all facial feature amounts including the representative facial feature amount of the camera 100 are added to a group including the representative facial feature amount of the PC 200. The case in which the same face dictionary group includes a plurality of facial feature amounts will be described in detail in another embodiment to be described later.

If the similarity is not equal to or larger than the threshold in step S1206, a face dictionary of the PC 200, a similarity of which is not compared, is acquired in step S1208.

It is determined in step S1209 whether or not all face dictionaries of the PC are compared with the person name or the similarity of face feature amounts. If comparison of all the face dictionaries is not complete yet, the process returns to step S1202 again to compare a person name of a face dictionary of the camera 100 with that of a face dictionary of the PC 200. If comparison of all the face dictionaries is complete in step S1209, since that facial feature amount does not belong to any group, a new group is generated in face dictionaries of the PC 200, and the facial feature amount of the camera 100 is added to that group in step S1210.

<Switching Processing of Merge Processing>

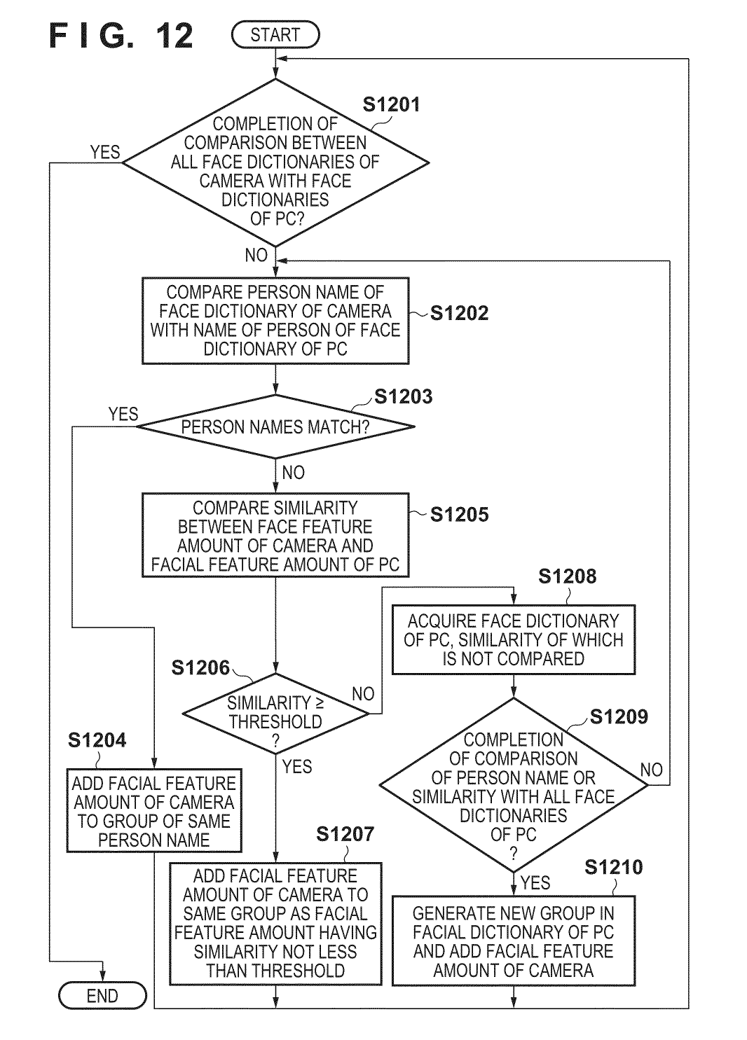

Processing for switching the merge processing by determining whether or not the face search algorithms of the camera 100 and PC 200 match will be described below with reference to FIG. 13.

Referring to FIG. 13, it is determined in step S1301 whether or not the PC 200 and camera 100 are connected, and “write face dictionary” is executed in the camera 100.

In step S1302, an ID of a face dictionary used in the face search algorithm of the camera 100 is acquired.

In step S1303, an ID of a face dictionary used in the face search algorithm of the PC 200 is acquired.

It is determined in step S1304 whether or not the IDs of the face dictionaries of the camera 100 and PC 200 match, that is, whether or not the same face dictionary is used. This is because if the same face dictionary is used, a facial feature amount calculated from that face dictionary is used intact in the camera 100 and is also used in the face search algorithm.

Whether the face dictionaries are to be merged in the camera 100 or PC 200 is selected in step S1305. It is determined in step S1306 whether or not the face dictionaries are merged in the PC 200. If the face dictionaries are merged in the PC 200, the facial feature amount is transferred from the camera 100 to the PC 200, the face dictionaries are merged in the PC 200, and the merged face dictionary is transferred to the camera 100 in step S1307. On the other hand, if the face dictionaries are merged in the camera 100, the facial feature amount is transferred to the camera 100, and the face dictionaries are merged in the camera 100 in step S1308. In this manner, since the camera 100 need not analyze a facial feature amount from a face image, a time required to analyze the facial feature amount can be reduced.

If the IDs of the face dictionaries of the camera 100 and PC do not match in step S1304, since the facial feature amount of the face dictionary of the PC 200 cannot be used intact in the camera 100, face image data is transferred to the camera 100 and the face dictionaries are merged in the camera 100 in step S1309.

<Selection Processing of Main Body which Executes Merge Processing>

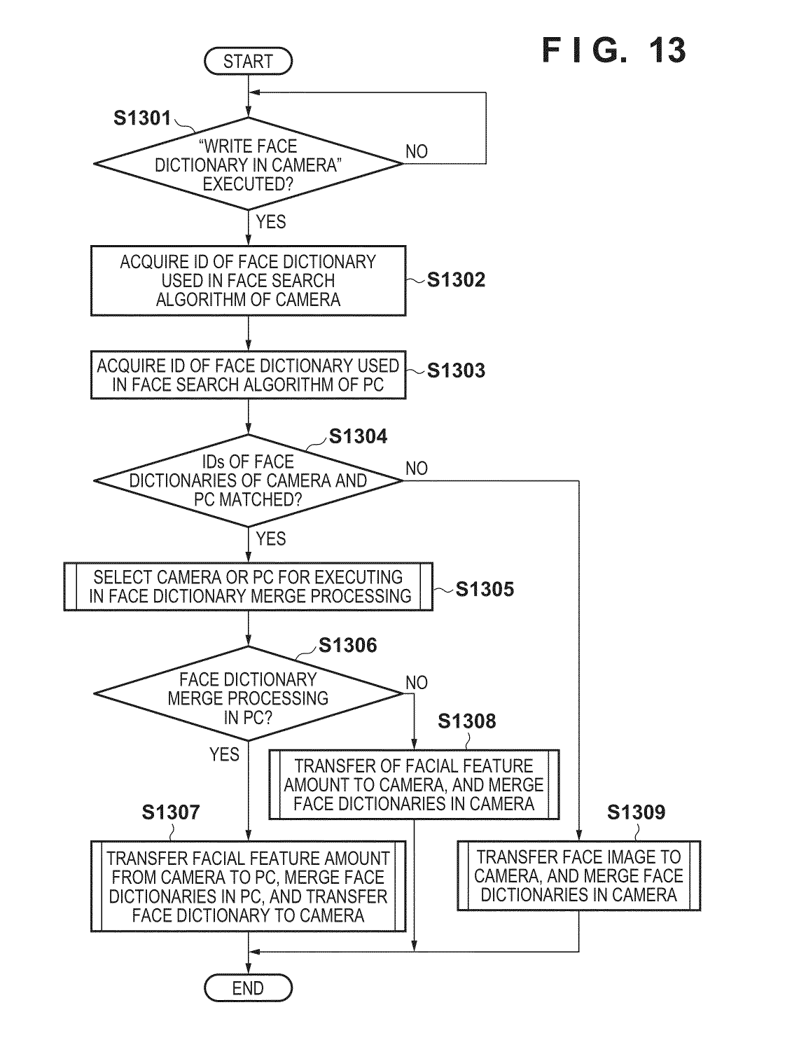

Selection processing of a main body which executes the merge processing in step S1305 in FIG. 13 will be described below with reference to FIG. 14.

Referring to FIG. 14, in step S1401, the user selects the camera 100 or PC 200 to merge face dictionaries. Note that the PC 200 used to execute the merge processing may be selected as a default, and settings may be allowed to be changed later by the application.

It is determined in step S1402 whether or not the user selects the camera 100 to execute the merge processing. If the user selects the camera 100 to execute the merge processing, a setting indicating that the camera 100 is selected to merge face dictionaries is stored in step S1403. If the user selects the PC 200 used to execute the merge processing, a setting indicating that the PC 200 is selected to merge face dictionaries is stored in step S1404.

<Merge Processing in Camera>

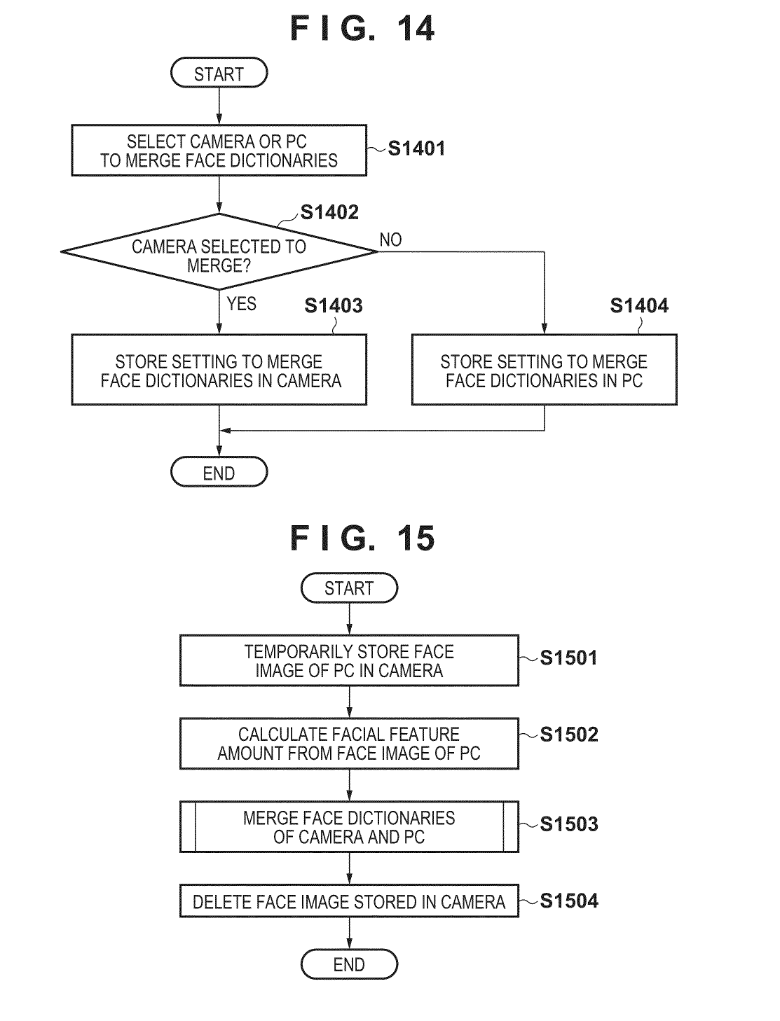

Processing for transferring face image data to the camera and merging face dictionaries in the camera in step S1309 in FIG. 13 will be described below with reference to FIG. 15.

Referring to FIG. 15, in step S1501, face image data of the PC 200 is transferred to the camera 100, and is stored in a storage area of the primary storage device 104 of the camera 100. As this storage area, the secondary storage device 105 and storage medium 106 may be used in addition to the primary storage device 104 of the camera 100.

In step S1502, the camera 100 calculates a facial feature amount from the face image data of the PC 200. Since the face search algorithm is different (NO in step S1304 in FIG. 13), the camera 100 has to calculate the facial feature amount by its own face search algorithm to be able to interpret that facial feature amount by itself.

In step S1503, the camera 100 merges the face dictionaries of the camera 100 and PC 200.

In step S1504, the camera 100 deletes the face image data stored in the storage area of the primary storage device 104 of the camera 100.

<Setting of Similarity>

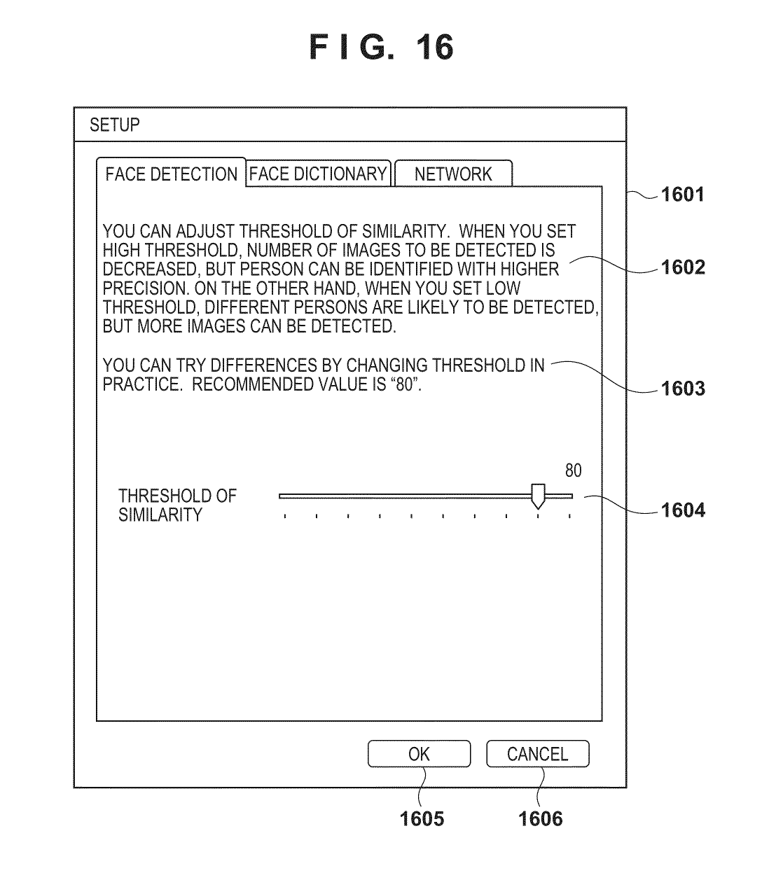

FIG. 16 shows an example of a dialog used to change a threshold of a similarity in the face search algorithm of this embodiment. Reference numeral 1601 denotes a setting dialog displayed by the application. Reference numeral 1602 denotes a face search tab displayed within the setting dialog 1601. Reference numeral 1603 denotes an explanatory text associated with a threshold of a similarity in the face search algorithm. This explanatory text describes that “When a high threshold is set, the number of images to be detected is decreased, but a person can be identified with high precision. On the other hand, when a low threshold is set, different persons are likely to be detected, but more images can be detected.” Reference numeral 1604 denotes a slider used to change the threshold of the similarity to a value falling within a range from 0 to 100. Reference numeral 1605 denotes an OK button used to settle the value set by the slider 1604. Reference numeral 1606 denotes a cancel button used to discard the value set by the slider 1604. By arbitrarily changing the threshold of the similarity, the number of images which hit the face dictionary group and precision can be adjusted.

<Face Dictionaries to be Merged and Selection of Subject>

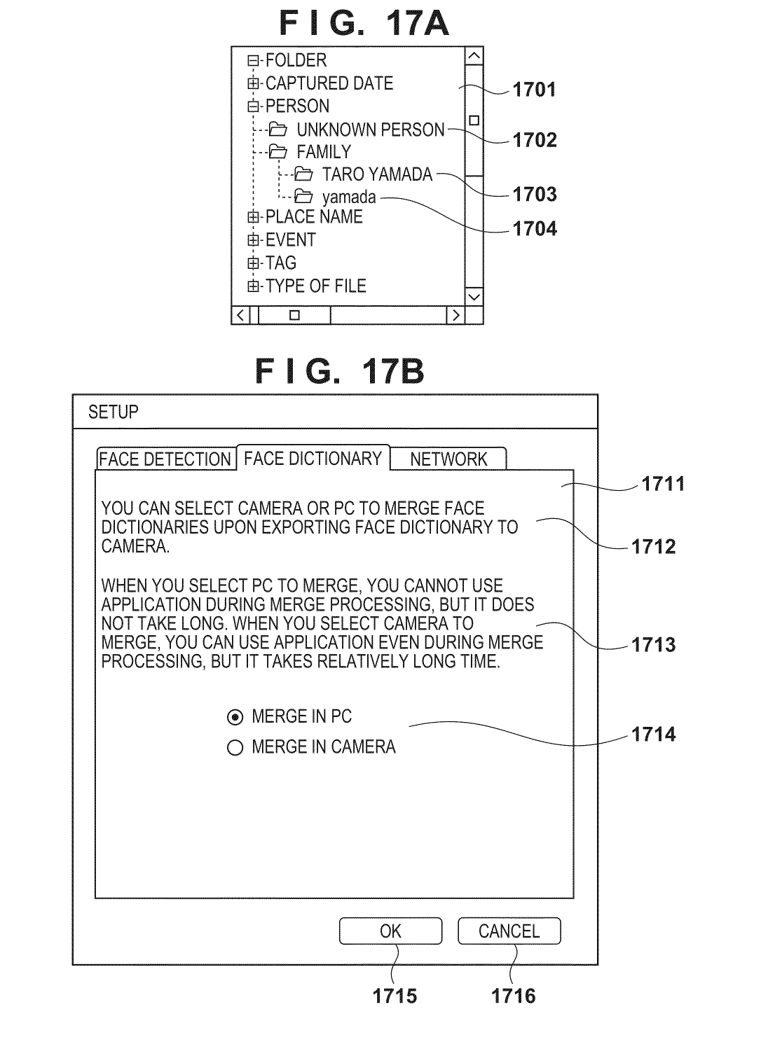

FIG. 17A shows an example of a setting screen used when person names are to be merged in this embodiment. Reference numeral 1701 denotes a tree view used to select a face dictionary to be merged upon merging face dictionaries. A folder 1702 includes face images, facial feature amounts of which are not associated with a person. A folder 1703 includes face images for which a person name “TARO YAMADA” is input of those in the folder 1702. Likewise, a folder 1704 includes face images for which a person name “yamada” is input of those in the folder 1702. When face images registered as “yamada” are the same as those registered as “TARO YAMADA”, it is convenient to merge these folders to one. For example, when the user wants to change “yamada” to “TARO YAMADA”, he or she right-clicks on the “yamada” folder and selects “merge face dictionaries”, thus displaying the tree view 1701. When the user selects “TARO YAMADA” on the tree view 1701, the control inquires the user as to whether or not to change all images registered as “yamada” to “TARO YAMADA”. Note that not only “yamada” is changed to “TARO YAMADA”, but also a dialog which prompts the user to input a name after the merge processing may be displayed.

FIG. 17B shows an example of a setting screen used to select a subject which merges face dictionaries in this embodiment. Reference numeral 1711 denotes a setting dialog displayed by the application. Reference numeral 1712 denotes a face dictionary type displayed on the setting dialog 1711. Reference numeral 1713 denotes an explanatory text in a case in which a face dictionary is merged to the camera 100 and a case in which the PC 200 or camera 100 merges face dictionaries. The explanatory text describes that “When the PC 200 executes the merge processing, other operations on the application are disabled during the merge processing, but a time required for merging is shorter than that of the merge processing on the camera 100.” When the PC 200 executes the merge processing, the application displays a modal progress bar to inhibit user operations. Reference numeral 1714 denotes radio buttons used to select whether the PC 200 or camera 100 executes the merge processing. Reference numeral 1715 denotes an OK button used to settle the value set by the radio buttons 1714. Reference numeral 1716 denotes a cancel button used to discard the value set by the radio buttons 1714.

<When Face Search Algorithms of Camera and PC are Different>

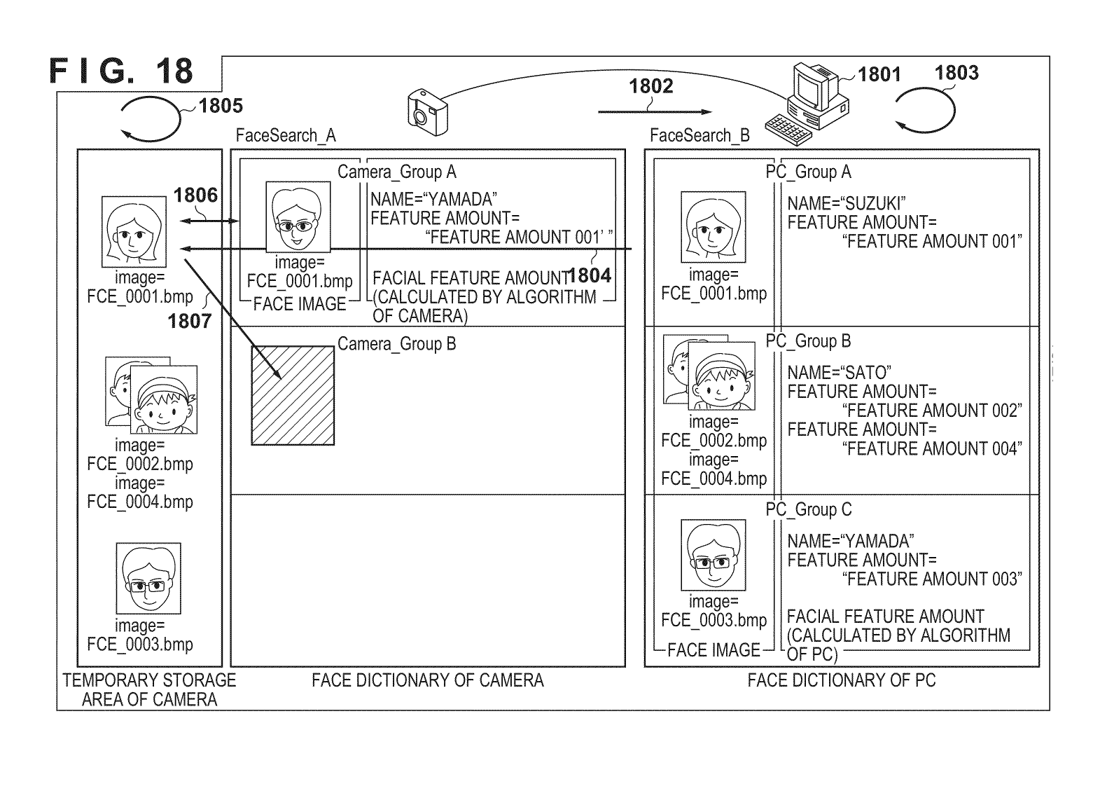

FIG. 18 is an explanatory view of processing for transferring face image data to the camera and merging face dictionaries in the camera in step S1305 in FIG. 13. In process 1801, the user connects the camera 100 and PC 200, and executes “add face dictionary to camera” on the application. In process 1802, an ID of a face dictionary used in the face search algorithm of the camera 100 is acquired. This ID is used to determine whether or not the camera 100 and PC 200 use the same face dictionary. In process 1803, an ID of a face dictionary used in the face search algorithm of the PC 200 is acquired. Then, the ID of the face dictionary used in the camera 100 is compared with that of the face dictionary used in the PC 200.

If the IDs of the face dictionaries are different, since facial feature amounts managed by the PC 200 cannot be recognized by the face search algorithm of the camera 100, only face images and person names are transferred to the camera 100, and facial feature amounts are calculated on the camera side again. In process 1804, the face images and pieces of information of person names of the PC 200 are transferred to a storage area of the primary storage device 104 of the camera 100. As this storage area, a RAM or memory card of the camera 100 may be used in addition to the primary storage device 104. In process 1805, the camera 100 calculates facial feature amounts from the face image data transferred from the PC 200. In process 1806, the camera 100 compares similarities between the facial feature amounts of the face dictionary of the camera 100 and the facial feature amounts calculated in process 1805. In process 1807, the camera 100 merges the facial feature amounts of the face dictionary of the camera 100 with those newly calculated in process 1805. This merge processing is executed based on the sequence described using FIG. 12. Note that FIG. 12 describes only the sequence for adding only facial feature amounts to the face dictionary. However, the face images can also be registered in the face dictionary. In this case, a representative image can also be selected.

<When Face Search Algorithms of Camera and PC are Same>

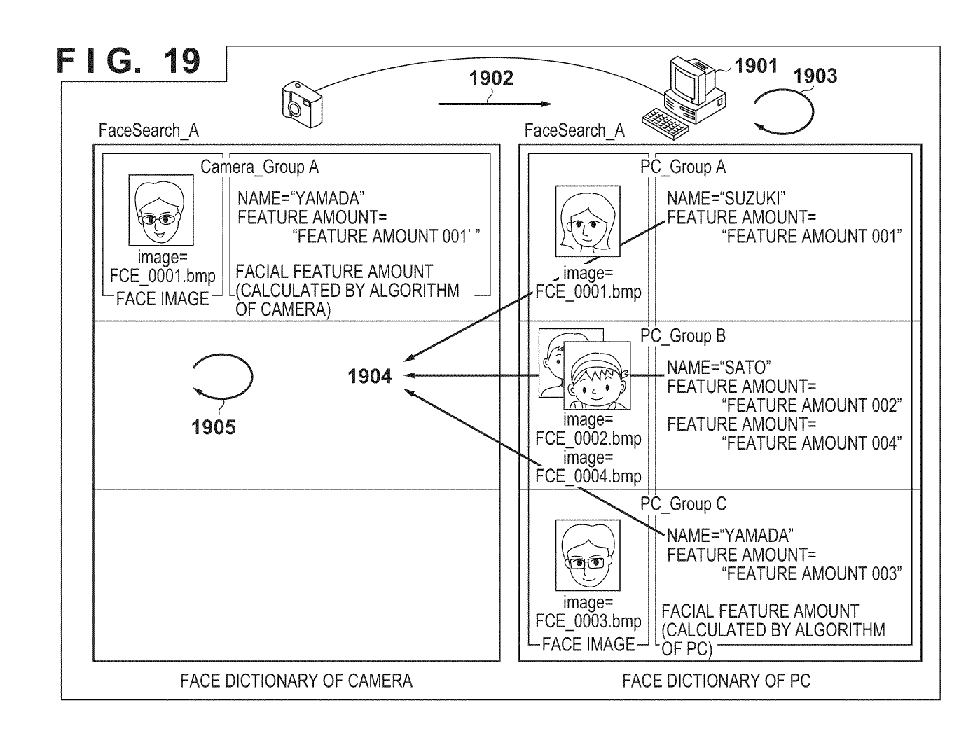

FIG. 19 is an explanatory view of processing for transferring facial feature amounts to the camera and merging the facial feature amounts in the camera in step S1308 in FIG. 13. In process 1901, the user connects the camera 100 and PC 200 and executes “add face dictionary to camera” on the application. In process 1902, an ID of a face dictionary used in the face search algorithm of the camera 100 is acquired. In process 1903, an ID of a face dictionary used in the face search algorithm of the PC 200 is acquired, and the IDs of the face dictionaries used in the camera 100 and PC 200 are compared. When the IDs match, since facial feature amounts managed by the PC 200 can be recognized by the face search algorithm of the camera 100, only facial feature amounts and person names are transferred to the camera 100. In process 1904, the facial feature amounts and person names of the PC 200 are transferred to the camera 100. In process 1905, the camera 100 merges the facial feature amounts of the PC 200 transferred from the PC 200 with those of the camera 100. This merge processing is executed based on the sequence described using FIG. 12.

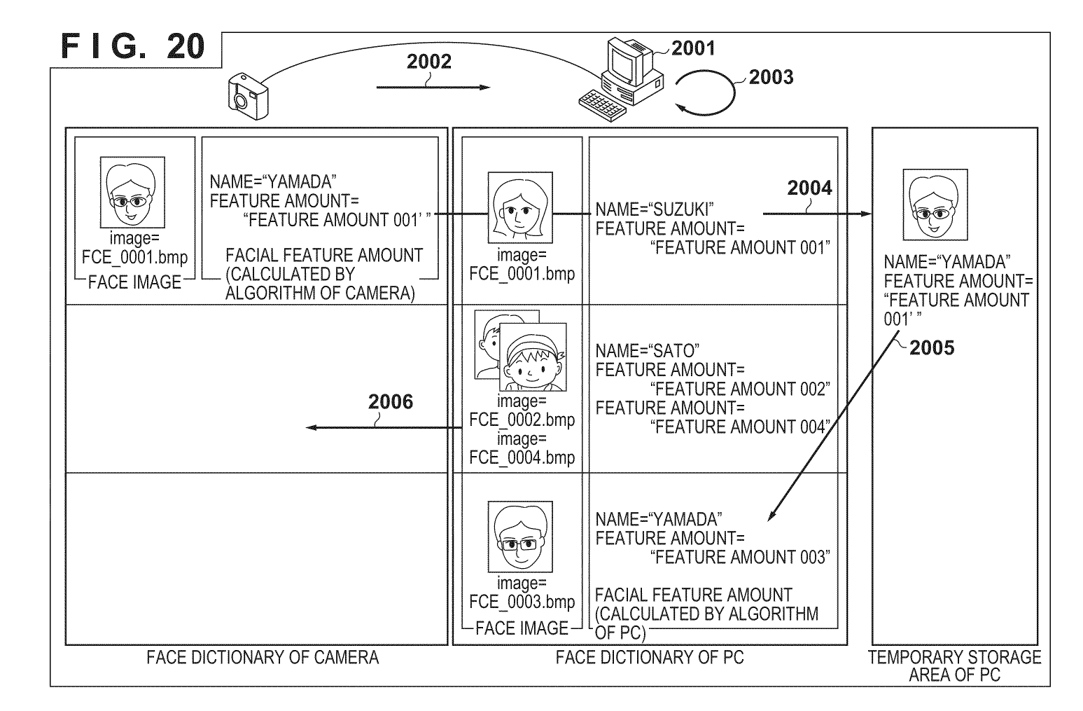

FIG. 20 is an explanatory view of processing for merging face dictionaries in the PC and transferring the merged face dictionary to the camera in step S1307 in FIG. 13. In process 2001, the user connects the camera 100 and PC 200 and executes “transfer face dictionary to camera” on the application. In process 2002, an ID of a face dictionary used in the face search algorithm of the camera 100 is acquired. In process 2003, an ID of a face dictionary used in the face search algorithm of the PC 200 is acquired, and the IDs of the face dictionaries used in the camera 100 and PC 200 are compared. If the IDs match, since facial feature amounts managed by the PC 200 can be recognized by the face search algorithm of the camera 100, only the facial feature amounts and a person name are transferred to the PC 200. In process 2004, the face dictionary of the camera 100 is copied to a storage area of the primary storage device 204 of the PC 200. In process 2005, the face dictionary of the PC 200 and that of the camera 100 stored in the primary storage device 204 are merged. This merge processing is executed based on the sequence described using FIG. 12. In process 2006, the merged face dictionary is transferred to the camera 100.

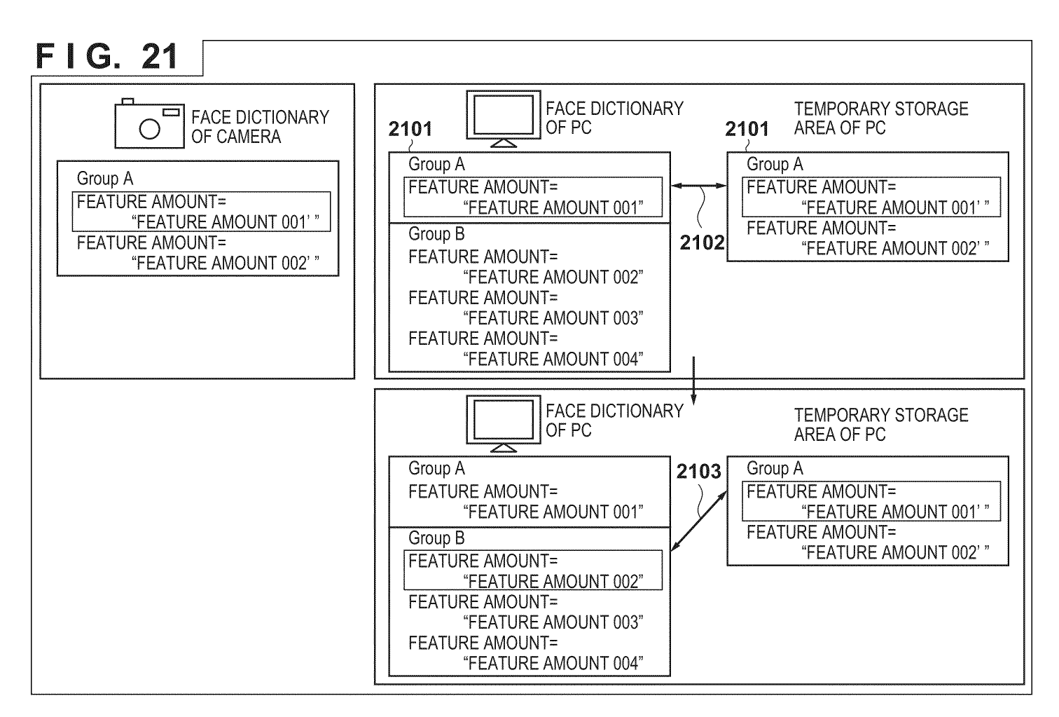

FIG. 21 is an explanatory view of processing executed when the application on the PC side compares facial feature amounts of face dictionaries of the PC and camera and merges them. In process 2101, it is confirmed if a single group of a face dictionary includes a plurality of facial feature amounts. If a plurality of facial feature amounts are included, a representative facial feature amount is selected from them. The same processing is applied to a face dictionary transferred from the camera 100. This is because when a single group of the face dictionary includes a plurality of facial feature amounts, and when all the facial feature amounts of the camera 100 and PC 200 are compared, facial feature amounts which originally belong to a single group are likely to belong to different groups after the merge processing. When Group A of the face dictionary of the PC 200 includes only one facial feature amount, “facial feature amount 001” is to be compared. On the other hand, since “facial feature amount 001′” and “facial feature amount 002′” are registered in Group A of the face dictionary of the camera 100, a representative facial feature amount of Group A is selected. In this case, “facial feature amount 001′” which is registered earlier is selected as a representative facial feature amount. However, the user may select which facial feature amount is proper based on face images.

In process 2102, “facial feature amount 001” of Group A of the face dictionary of the PC 200 is compared with “facial feature amount 001′” as the representative facial feature amount of Group A of the face dictionary of the camera 100 and it is determined whether or not their similarity is equal to or larger than a threshold. In process 2103, if the similarity is less than the threshold, “facial feature amount 002” of Group B of the face dictionary of the PC 200 is compared with “facial feature amount 001′” as the representative facial feature amount of Group A of the face dictionary of the camera 100 and it is determined whether or not their similarity is equal to or larger than the threshold. If the similarity is equal to or larger than the threshold, “facial feature amount 001′” and “facial feature amount 002′” registered in Group A of the face dictionary of the camera 100 are added to Group B of the face dictionary of the PC. This is because when a single group includes a plurality of facial feature amounts, if all of them are not added to the same group, facial feature amounts which originally belong to the single group are likely to belong to different groups. For example, when a similarity between “facial feature amount 001′” registered in Group A of the face dictionary of the camera 100 and “facial feature amount 002” registered in Group B of the face dictionary of the PC 200 is equal to or larger than the threshold, and a similarity between “facial feature amount 002′” of the camera 100 and “facial feature amount 001” registered in Group A of the face dictionary of the PC 200 is equal to or larger than the threshold, “facial feature amount 001′” and “facial feature amount 002′” which are registered in Group A of the face dictionary of the camera 100 unwantedly belong to different groups. For this reason, a similarity is compared based on the representative facial feature amount, and if it is determined that the similarity is equal to or larger than the threshold, all facial feature amounts of the camera 100, which belong to the single group, are merged to the face dictionary of the PC. This method is merely an example, and facial feature amounts may be merged by another means.

<Image Display Example>

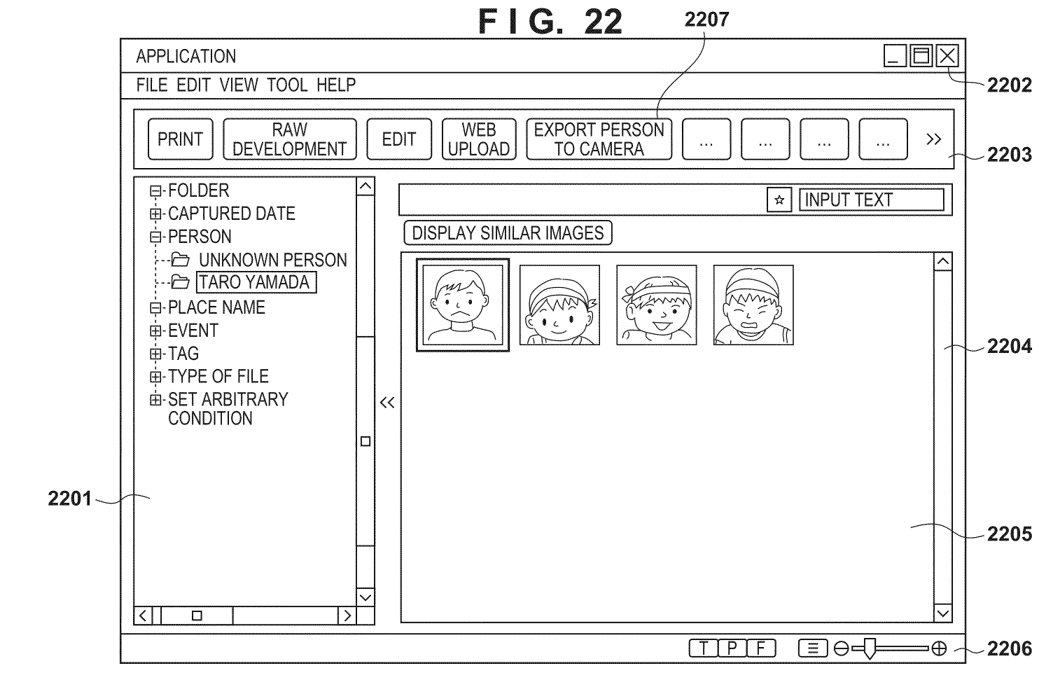

FIG. 22 shows an example of a window which displays images registered in the face dictionary by the application of the PC 200. When the user designates a folder in a tree view 2201, thumbnails of files included in that folder can be displayed. The PC 200 displays thumbnail images if they are included in image files or other files. If no thumbnail images are available, the PC 200 generates thumbnails from original images, and displays these thumbnails as a list in a browser window 2205. In this case, the tree view 2201 displays a face dictionary folder in which face images and a person name are associated with each other. When the user selects the face dictionary named “TARO YAMADA”, images of a person corresponding to “TARO YAMADA” are displayed on the browser window 2205. Reference numeral 2202 denotes normally equipped window control buttons of the application (“minimize”, “maximize”, and “close” in turn from the left). When that folder includes a large number of images, a scroll bar 2204 is displayed in a valid state beside the browser window 2205. For example, a slider 2206 is a controller used to change a size of each thumbnail displayed on the browser window 2205. When all of thumbnails with a large size cannot be displayed within the browser window, the scroll bar 2204 is displayed in a valid state. Reference numeral 2203 denotes buttons used to make arbitrary actions for images displayed on the browser window 2205.

A UI upon selection of an “export person to camera” button 2207 so as to transfer the face dictionary of the PC 200 to the camera 100 like in this embodiment will be described below.

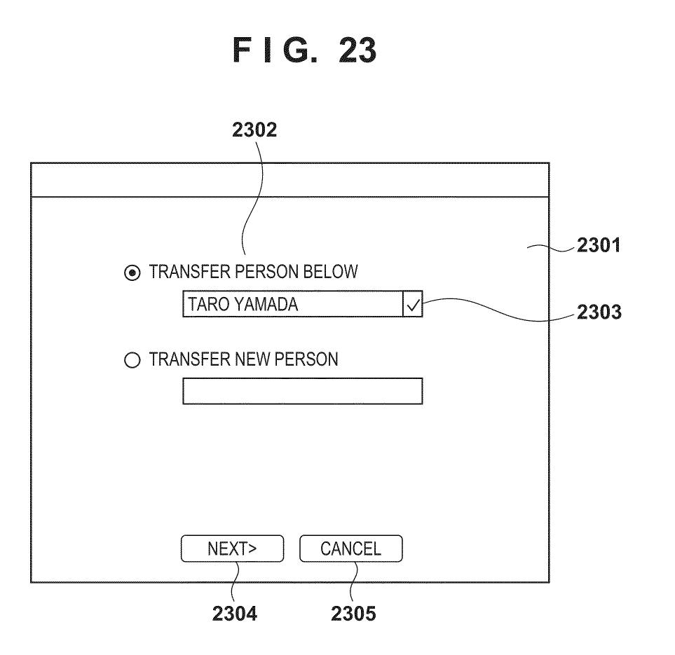

FIG. 23 shows an example of a dialog used to select a face dictionary to be transferred from the PC to the camera. Reference numeral 2301 denotes a dialog displayed when the “export person to camera” button 2207 is selected from the buttons 2203 of the PC 200. Reference numeral 2302 denotes radio buttons used to select whether a face dictionary already found in the PC 200 is transferred or a newly generated face dictionary is transferred. Reference numeral 2303 denotes a combo box used to select a stored face dictionary when the already stored face dictionary is selected using the radio button 2302. A case will be described below wherein “TARO YAMADA” registered in the face dictionary of the PC 200 is to be transferred to the camera 100. Reference numeral 2304 denotes a button used to transit to the next step. Reference numeral 2305 denotes a button used to close the dialog by aborting the transfer processing to the camera 100.

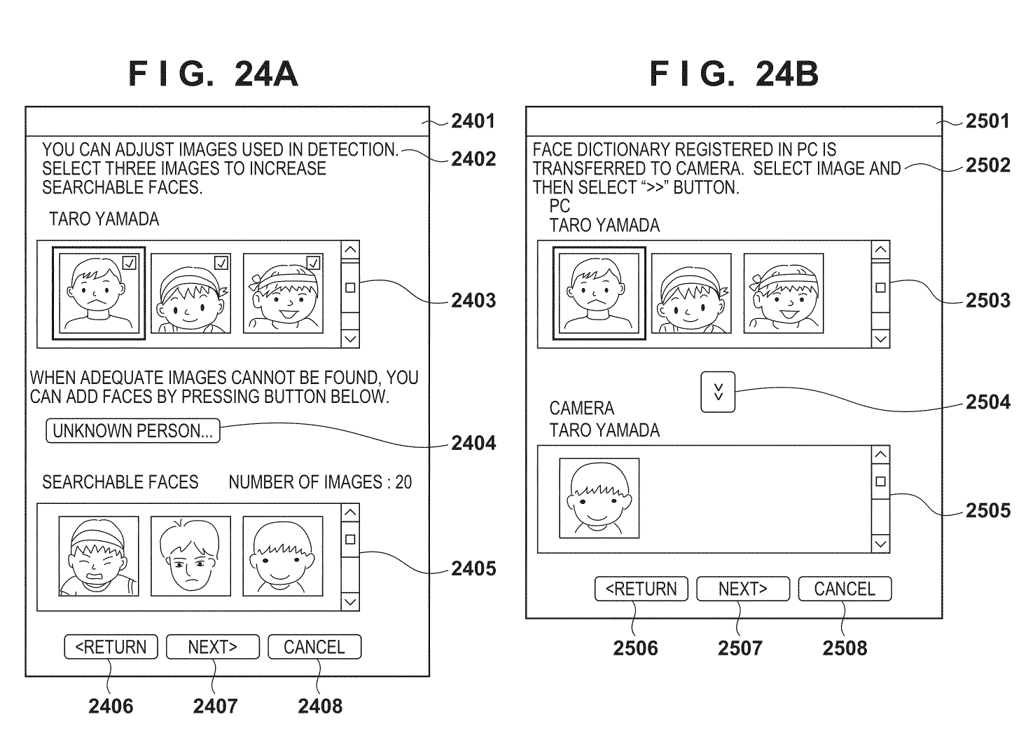

FIG. 24A shows an example of a dialog used to select a face image used in the face search algorithm in the application of the PC 200. Reference numeral 2401 denotes a dialog displayed when the button 2304 of the dialog 2301 is selected. When the face dictionary used in the face search algorithm of the PC 200 is different from that used in the face search algorithm of the camera 100, no dialog used to adjust a search result is displayed. This is because since the camera 100 cannot use facial feature amounts of the face dictionary of the PC 200, faces displayed on the dialog cannot often be detected by the camera 100. Reference numeral 2402 denotes an explanatory text which describes that face images used in the face search algorithm of those of “TARO YAMADA” are adjusted. Reference numeral 2403 denotes a display area used to select face images used in the face search algorithm from those of “TARO YAMADA” registered in the PC 200. Reference numeral 2404 denotes a button used to display a dialog from which face images of an unnamed unknown person are to be selected when there is no adequate face. Reference numeral 2405 denotes a display area which displays face images having similarities equal to or larger than the threshold according to the facial feature amounts of the face images selected on the display area 2403. This area also displays the number of corresponding images. Reference numeral 2406 denotes a button used to transit to the previous step. Reference numeral 2407 denotes a button used to transit to the next step. Reference numeral 2408 denotes a button used to close the dialog by aborting the transfer processing to the camera 100.

FIG. 24B shows an example of a dialog used to transfer face images of the PC to the camera 100. Reference numeral 2501 denotes a dialog displayed when the button 2407 on the dialog 2401 is selected. Reference numeral 2502 denotes an explanatory text which describes an operation required to designate face images to be transferred to the camera 100 of those of “TARO YAMADA”. Reference numeral 2503 denotes a display area used to select face images used in the face search algorithm from those of “TARO YAMADA” registered in the PC 200. Reference numeral 2504 denotes a button used to copy face images selected on the display area 2503 to a display area 2505 on which a face image of the face dictionary of the camera 100 is registered. Reference numeral 2505 denotes a display area used to display a face image of “TARO YAMADA” registered in the camera 100. In the example of FIG. 24B, one face image of “TARO YAMADA” is already stored in the camera 100. Note that as a modification, a face image stored in the camera 100 may be selected, and the button 2504 may be selected to transfer the face image from the camera 100 to the PC 200. Reference numeral 2506 denotes a button used to transit to the previous step. Reference numeral 2507 denotes a button used to transit to the next step. Reference numeral 2508 denotes a button used to close the dialog by aborting the transfer processing to the camera 100.

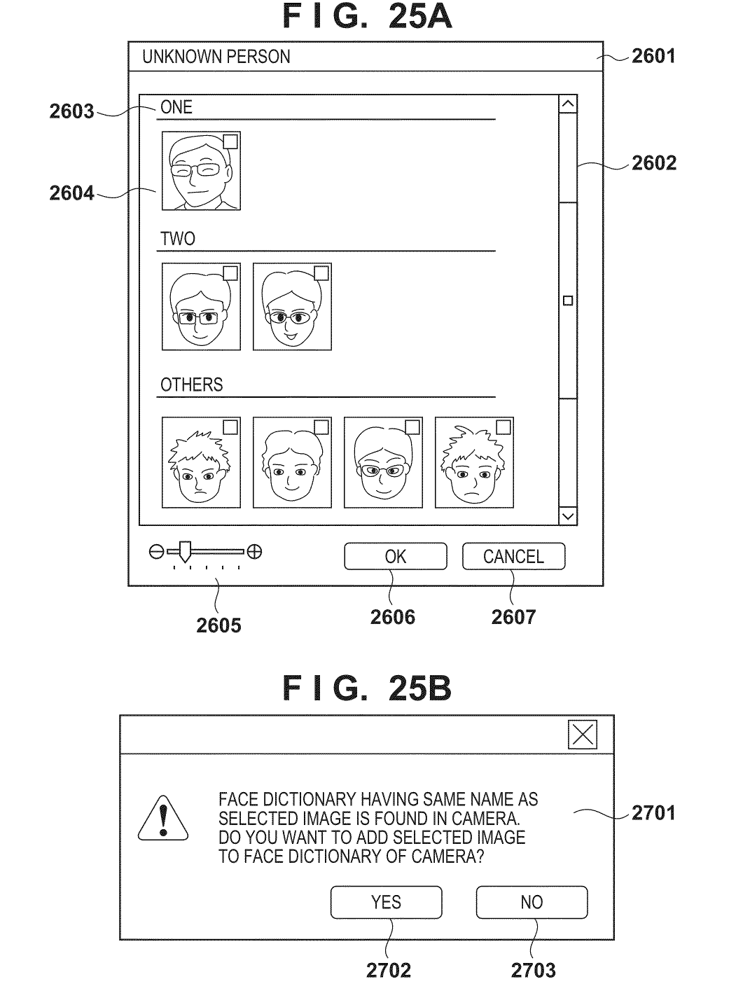

FIG. 25A shows an example of a dialog 2601 used to select face images from an unknown person. This dialog is displayed when the button 2404 on the dialog 2401 is selected. When a large number of face images for which person names are not designated are stored like in this embodiment, a scroll bar 2602 is displayed in a valid state. Reference numeral 2603 denotes a separator line used to emphasize that face images do not belong to a single group. Reference numeral 2604 denotes a display area which displays detected face images. For example, when the user selects a check box displayed on the upper right corner of each face image and selects a button 2606, face images similar to a facial feature amount of the checked face image are detected, and are displayed on the display area 2405. A slider 2605 is a controller used to change a size of each thumbnail displayed on the display area 2604. A button 2607 is used to close the dialog by ignoring settings selected on the dialog 2601.

FIG. 25B shows a display example of a warning message when the face dictionary of the same name is found upon transferring the face dictionary from the PC to the camera. A warning message 2701 is displayed to confirm the user as to whether or not the face dictionary of the PC 200 is to be written in the face dictionary of the same name of the camera 100. When the user selects a button 2702, the control transits to the next step. When the user selects a button 2703, the processing for writing the face dictionary of the PC 200 in the face dictionary of the camera 100 having the same name is aborted.

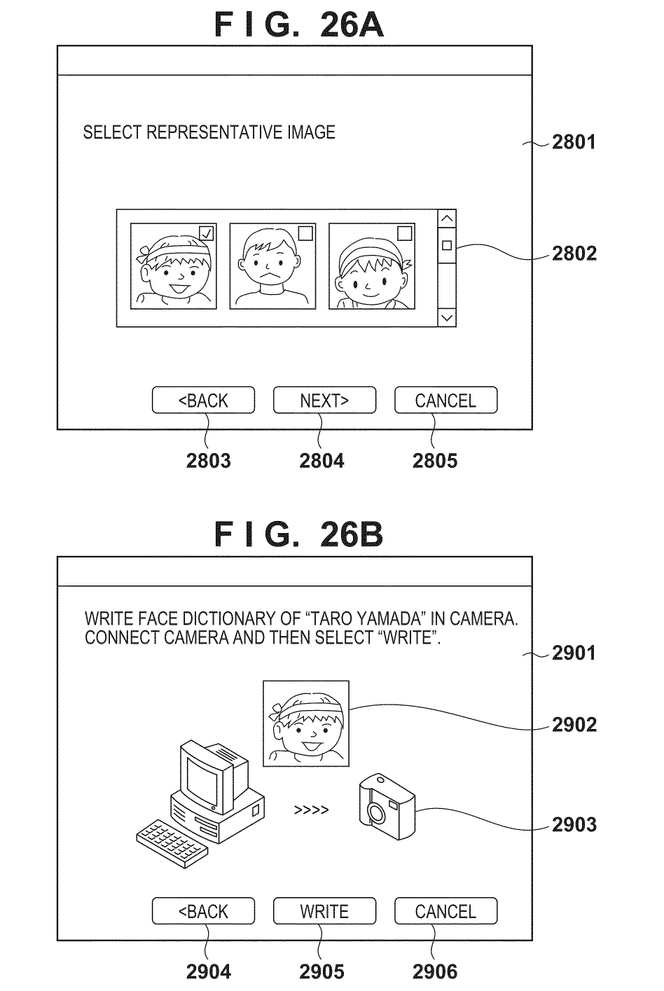

FIG. 26A shows a dialog 2801 used to arbitrary select a representative image when the face dictionary of a single person includes a plurality of face images. This dialog is displayed when the user selects the button 2702 of the warning message 2701 or the button 2507 of the dialog 2501. Reference numeral 2802 denotes a display area used to select a representative image to be displayed on the camera 100 when a plurality of face images are found. Reference numeral 2803 denotes a button used to transit to the previous step. Reference numeral 2804 denotes a button used to transit to the next step. Reference numeral 2805 denotes a button used to close the dialog by aborting the transfer processing to the camera 100.

FIG. 26B shows a dialog 2901 which confirms the user that the selected face dictionary is written in the camera 100. This dialog is displayed when the user selects the button 2804 of the dialog 2801. Reference numeral 2902 denotes a representative image selected on the dialog 2801. Reference numeral 2903 denotes an illustration indicating that the face image 2902 is transferred from the PC 200 to the camera 100. This process may be displayed as an animation. Reference numeral 2904 denotes a button used to transit to the previous step. Reference numeral 2905 denotes a button used to write the face image in the camera 100. When the camera 100 and PC 200 are not connected, a message which prompts the user to connect the camera 100 and PC 200 is displayed. Reference numeral 2906 denotes a button used to close the dialog by aborting the transfer processing to the camera 100.

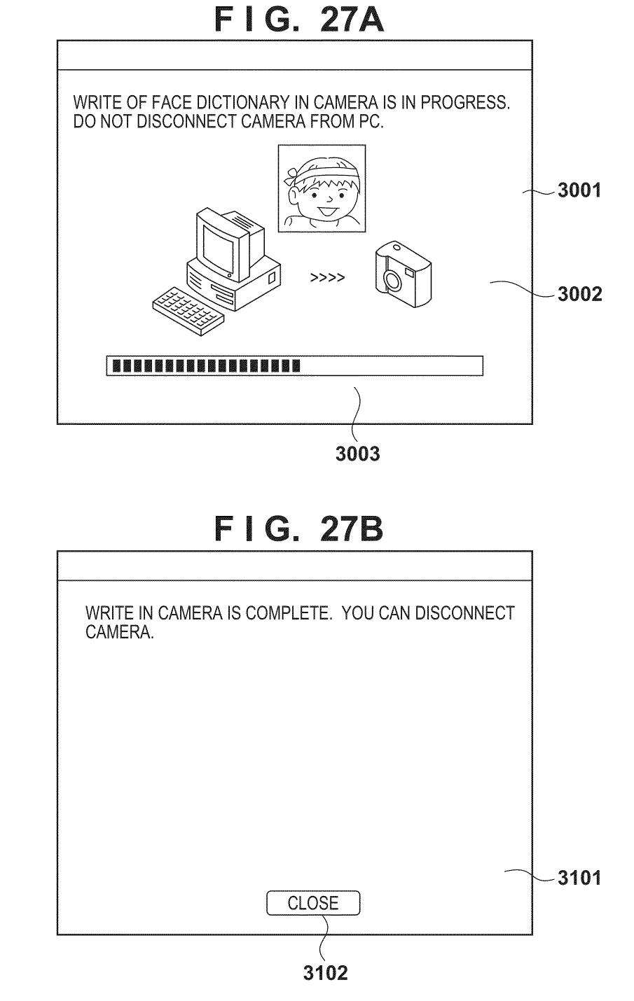

FIG. 27A shows a dialog 3001 displayed during the write processing of the face image from the PC to the camera. This dialog is displayed when the user selects the button 2905 of the dialog 2901. Reference numeral 3002 denotes an illustration indicating that the face image is transferred from the PC 200 to the camera 100. This process may be displayed as an animation. Reference numeral 3003 denotes a progress bar indicating a degree of progress of the processing until the face dictionaries of the PC 200 and camera 100 are merged and transferred. The dialog 3001 may be displayed in a modal state so as to inhibit the user from executing another operation during the merge processing of the face dictionaries.

FIG. 27B shows a dialog 3101 displayed when the write processing of the face dictionary in the camera 100 is complete. This dialog is displayed upon completion of the processing of the dialog 3001. When the user selects a button 3102, the dialog 3101 is closed.

According to this embodiment, since the face dictionary of the PC can be merged with that of the camera, person specifying precision on the camera can be improved. Confirmation of a person and an input operation of the name of a person can be made easier than when a face dictionary is generated on the camera side, thus improving convenience.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-184065, filed Aug. 25, 2011, which is hereby incorporated by reference herein in its entirety.

What is claimed is:

1. An information processing apparatus, which has a function of specifying a person included in image data, comprising:
a generation unit configured to generate dictionary data in which unique information is registered for each person, and to store the dictionary data in a storage unit;
a search unit configured to extract a feature amount of an object included in image data, and to check the dictionary data to specify a person;
a communication unit configured to communicate with an image capturing apparatus having a function of specifying a person included in image data using dictionary data; and
a transmitting unit configured to compare dictionary data of the image capturing apparatus with the dictionary data stored in the storage unit in a state in which said information processing apparatus is communicating with the image capturing apparatus via said communication unit, and to transmit the dictionary data stored in the storage unit, when the dictionary data stored in the storage unit is newer, to the image capturing apparatus to update the dictionary data of the image capturing apparatus.

2. The apparatus according to claim 1, wherein the dictionary data has an information file for each person, and the information file includes face image data, a captured date, and identification information, and
a plurality of dictionary data are generated for predetermined age groups for a single person.

3. The apparatus according to claim 1, further comprising:
a determination unit configured to determine whether or not dictionary data stored in the storage unit include dictionary data which are not stored in the image capturing apparatus;
a registration unit configured to register, when the dictionary data which are not stored in the image capturing apparatus, are found, dictionary data, which are not separated by not less than a predetermined interval from a current date of the found dictionary data in a list; and
a selection unit configured to arbitrarily select dictionary data to be added to the image capturing apparatus from the list.

4. The apparatus according to claim 1, further comprising:
a transfer unit configured to transfer image data to the image capturing apparatus via said communication unit; and
a determination unit configured to determine based on a feature amount of an object extracted from the image data whether or not corresponding dictionary data is found in the storage unit upon transferring the image data,
wherein when the corresponding dictionary data is found in the storage unit, said transmitting unit transfers the image data and the corresponding dictionary data to the image capturing apparatus.

5. The apparatus according to claim 1, further comprising:
a selection unit configured to select image data to be deleted from the image capturing apparatus; and
a determination unit configured to determine based on a feature amount of an object extracted from the selected image data whether or not corresponding dictionary data is found in the storage unit upon deleting the image data; and
a dictionary edit unit configured to instruct the image capturing apparatus to delete the selected image data and the corresponding dictionary data from the image capturing apparatus when the corresponding dictionary data is found in the image capturing apparatus.

6. An information processing apparatus, which has a function of specifying a person included in image data, comprising:
a generation unit configured to generate dictionary data in which unique information is registered for each person, and to store the dictionary data in a storage unit;
a search unit configured to extract a feature amount of an object included in image data, and to check the dictionary data to specify a person;
a communication unit configured to communicate with an image capturing apparatus having a function of specifying a person included in image data using dictionary data;
an acquisition unit configured to acquire dictionary data from the image capturing apparatus;
a determination unit configured to determine whether or not the dictionary data acquired from the image capturing apparatus includes dictionary data of the same person as dictionary data stored in the storage unit; and
a merge unit configured to merge the dictionary data of the same person acquired from the image capturing apparatus with the dictionary data of the same person stored in the storage unit.

7. The apparatus according to claim 6, wherein even when the dictionary data acquired from the image capturing apparatus does not include dictionary data of the same person as dictionary data stored in the storage unit, said determination unit determines whether or not dictionary data having a similarity not less than a threshold is included, and
said merge unit merges the dictionary data having the similarity not less than the threshold with the dictionary data stored in the storage unit.

8. The apparatus according to claim 7, wherein said merge unit adds dictionary data having the similarity less than the threshold as new dictionary data.

9. The apparatus according to claim 7, further comprising:
a setting unit configured to arbitrarily set the threshold of the similarity.

10. The apparatus according to claim 6, wherein said merge unit merges the dictionary data of the same person acquired from the image capturing apparatus with the dictionary data of the same person stored in the storage unit, and transfers the merged dictionary data to the image capturing apparatus via said communication unit.

11. The apparatus according to claim 6, wherein said merge unit transfers the dictionary data of the same person stored in the storage unit to the image capturing apparatus via said communication unit so that the dictionary data of the same person stored in the storage unit is merged with the dictionary data of the same person of the image capturing apparatus in the image capturing apparatus.

12. The apparatus according to claim 6, wherein the image capturing apparatus comprises:
a search unit configured to specify a person included in a captured image and to display a name of the person on the image; and
a merge unit configured to merge dictionary data of the same person acquired from said information processing apparatus with dictionary data of the same person in the image capturing apparatus.

13. The apparatus according to claim 12, further comprising:
a selection unit configured to arbitrarily select whether merge processing of the dictionary data of the same person is executed by said information processing apparatus or the image capturing apparatus.

14. An image capturing apparatus, which captures an image of an object, comprising:
a generation unit configured to generate dictionary data in which unique information is registered for each person, and to store the dictionary data in a storage unit;
a search unit configured to extract a feature amount of an object included in image data, and to check the dictionary data to specify a person;
a communication unit configured to communicate with an information processing apparatus having a function of specifying a person included in image data using dictionary data; and
an update unit configured to update, when dictionary data newer than the dictionary data stored in the storage unit is transferred from the information processing apparatus, the dictionary data stored in the storage unit to the newer dictionary data in a state in which said image capturing apparatus is communicating with the information processing apparatus via said communication unit.

15. An image capturing apparatus, which captures an image of an object, comprising:
a generation unit configured to generate dictionary data in which unique information is registered for each person, and to store the dictionary data in a storage unit;
a search unit configured to extract a feature amount of an object included in image data, and to check the dictionary data to specify a person;
a communication unit configured to communicate with an information processing apparatus having a function of specifying a person included in image data using dictionary data;
an acquisition unit configured to acquire dictionary data from the information processing apparatus; and
a merge unit configured to merge dictionary data of the same person acquired from the information processing apparatus with dictionary data of the same person stored in the storage unit.

16. A control method of an information processing apparatus, which includes: a generation unit configured to generate dictionary data in which unique information is registered for each person, and to store the dictionary data in a storage unit; a search unit configured to extract a feature amount of an object included in image data, and to check the dictionary data to specify a person; and a communication unit configured to communicate with an image capturing apparatus having a function of specifying a person included in image data using dictionary data, the method comprising:
a step of comparing dictionary data of the image capturing apparatus with the dictionary data stored in the storage unit in a state in which the information processing apparatus is communicating with the image capturing apparatus via the communication unit; and
a step of transmitting the dictionary data stored in the storage unit when the dictionary data stored in the storage unit is newer, to the image capturing apparatus to update the dictionary data of the image capturing apparatus.

17. A control method of an information processing apparatus, which includes: a generation unit configured to generate dictionary data in which unique information is registered for each person, and to store the dictionary data in a storage unit; a search unit configured to extract a feature amount of an object included in image data, and to check the dictionary data to specify a person; and a communication unit configured to communicate with an image capturing apparatus having a function of specifying a person included in image data using dictionary data, the method comprising:
an acquisition step of acquiring dictionary data from the image capturing apparatus;
a determination step of determining whether or not the dictionary data acquired from the image capturing apparatus includes dictionary data of the same person as dictionary data stored in the storage unit; and
a merge step of merging the dictionary data of the same person acquired from the image capturing apparatus with the dictionary data of the same person stored in the storage unit.

18. A control method of an image capturing apparatus, which has: an image capturing unit configured to capture an image of an object; a generation unit configured to generate dictionary data in which unique information is registered for each person, and to store the dictionary data in a storage unit; a search unit configured to extract a feature amount of the object included in image data, and to check the dictionary data to specify a person; and a communication unit configured to communicate with an information processing apparatus having a function of specifying a person included in image data using dictionary data, the method comprising:
a step of updating, when dictionary data newer than the dictionary data stored in the storage unit is transferred from the information processing apparatus, the dictionary data stored in the storage unit to the newer dictionary data in a state in which the image capturing apparatus is communicating with the information processing apparatus via the communication unit.

19. A control method of an image capturing apparatus, which has: an image capturing unit configured to capture an image of an object; a generation unit configured to generate dictionary data in which unique information is registered for each person, and to store the dictionary data in a storage unit; a search unit configured to extract a feature amount of the object included in image data, and to check the dictionary data to specify a person; and a communication unit configured to communicate with an information processing apparatus having a function of specifying a person included in image data using dictionary data, the method comprising:
an acquisition step of acquiring dictionary data from the information processing apparatus; and
a merge step of merging dictionary data of the same person acquired from the information processing apparatus with dictionary data of the same person stored in the storage unit.
